(19) United States
(12) Patent Application Publication
(10) Pub. No.: US 2023/0333861 A1
(43) Pub. Date: Oct. 19, 2023

(54) CONFIGURING A COMPONENT OF A PROCESSOR CORE BASED ON AN ATTRIBUTE OF AN OPERATING SYSTEM PROCESS

(71) Applicant: SiFive, Inc., San Mateo, CA (US)

(72) Inventors: Krste Asanovic, Oakland, CA (US); Paul Walmsley, Silver City, NM (US); John Ingalls, Sunnyvale, CA (US)

(21) Appl. No.: 18/191,074

(22) Filed: Mar. 28, 2023

Related U.S. Application Data
(60) Provisional application No. 63/331,288, filed on Apr. 15, 2022.

(51) Int. Cl. G06F 9/445

(52) U.S. Cl. CPC G06F 9/44505

(57) ABSTRACT

A first operating system process may be identified. The first operating system process may have instructions configured to be executed by a processor core. A first set of parameters may be determined based on an attribute of the first operating system process. For example, the first set of parameters may be determined based on an address space identifier, an address space stored in a page table base register, a virtual machine identifier, or a combination thereof. A component of the processor core may be configured using the first set of parameters. For example, one or more components, such as a branch predictor, a prefetcher, a dispatch unit, a vector unit, a clock controller, and the like, may be configured using the first set of parameters.

### CROSS-REFERENCE TO RELATED APPLICATION(S)

This application claims priority to and the benefit of U.S. Provisional Patent Application Ser. No. 63/331,288, filed Apr. 15, 2022, the entire disclosure of which is hereby incorporated by reference.

### TECHNICAL FIELD

This disclosure relates generally to central processing units or processor cores and, more specifically, to configuring a component of a processor core based on an attribute of an operating system process.

### BACKGROUND

A central processing unit (CPU) or processor core may be implemented according to a particular microarchitecture. As used herein, a “microarchitecture” refers to the way an instruction set architecture (ISA) (e.g., the RISC-V instruction set) is implemented by a processor core. A microarchitecture may be implemented by various components, such as dispatch units, execution units, registers, caches, queues, data paths, and/or other logic associated with instruction flow. A processor core may execute instructions based on the microarchitecture that is implemented.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of a processing system that implements a microarchitecture.

FIG. 2 is a block diagram of an example of a system including a processor core and a memory system.

FIG. 3 is a block diagram of an example of configuring one or more components of a processor core on a per process basis.

FIG. 4 is a block diagram of another example of configuring one or more components of a processor core on a per process basis.

FIG. 5 is a block diagram of another example of configuring one or more components of a processor core on a per process basis.

FIG. 6 is a block diagram of another example of configuring one or more components of a processor core on a per process basis.

FIG. 7 is a block diagram of another example of configuring one or more components of a processor core on a per process basis.

FIG. 8 is a block diagram of another example of configuring one or more components of a processor core on a per process basis.

FIG. 9 is a block diagram of another example of configuring one or more components of a processor core on a per process basis.

FIG. 10 is a block diagram of another example of configuring one or more components of a processor core on a per process basis.

FIG. 11 is a block diagram of another example of configuring one or more components of a processor core on a per process basis.

FIG. 12 is a flow chart of an example of a process for configuring a component of a processor core based on an attribute of a process.

FIG. 13 is a block diagram of an example of a system for facilitating generation and manufacture of integrated circuits.

FIG. 14 is a block diagram of an example of a system for facilitating generation of integrated circuits.

### DETAILED DESCRIPTION

Operating system processes (or simply “processes”) executing in a processor core may have different characteristics or behaviors. For example, a process associated with a web browser may access memory differently than a process associated with a mathematically intensive program that may be executing many matrix multiplication operations. Moreover, a process may behave differently at different times during its own execution. For example, a process may go through different phases during its execution, such as a first phase involving relatively more memory accesses (such as a data gathering phase or an input phase), followed by a second phase involving relatively fewer memory accesses (such as a data processing phase or an output phase). While certain microarchitectures or components thereof may adapt responsive to operating conditions of its components, such adaptations may not be optimal or may result in inefficient operation because they are not selected responsive to an identification of an operating system process being executed by the processor core and the characteristics or behaviors of the executed process. For example, a component that adapts based on patterns of recent usage may not adapt quickly upon a context switch between processes because the new process must execute for a period of time to accumulate sufficient usage data to trigger an adaptation.

Implementations of this disclosure permit adapting one or more components of a microarchitecture to an operating system process based on an attribute of the process (e.g., tuning the microarchitecture based on the process). This may permit controlling characteristics or behaviors of the processor core as the processor core executes the process, such as performance (e.g., execution speed), power management, malware response, fault tolerance, and/or application security.

In some implementations, an operating system process configured to execute in a processor core may be identified. For example, a process may be identified by an attribute, such as an address space identifier (ASID) associated with the process (which may be stored in an address space register), and/or by an address space stored in a page table base register. Based on the attribute, a set of parameters (e.g., metadata used to control the processor core) may be determined for use with the process. In some implementations, the set of parameters may be determined by evaluating a model. For example, the process may be used to select a model from a library stored in a memory system, such as by using the attribute associated with the process to select the model. The model that is selected may specify the set of parameters to use for the process. In another example, the process may be input to a model, such as by inputting the attribute associated with the process to the model. The model may then indicate the set of parameters based on the process. In some implementations, the set of parameters may be determined dynamically, such as by learning the set of parameters while executing the process (e.g., collecting profiling information associated with the process and/or learning usage patterns associated with the process). Moreover, in some implementations, the set of parameters may be determined for one or more operational phases associated with a process (e.g., such as a first set of parameters determined for a data gathering phase or an input phase of the process, and a second set of parameters determined for a data processing phase or an output phase of the process). The set of parameters may be used to configure one or more components of the microarchitecture that is implemented by the processor core. For example, the set of parameters may be used to configure a prefetcher (which may implement a prefetch policy, such as a number of streams that the prefetcher will track, a distance associated with a fetch, a window associated with a fetch, allowing a linear to exponentially increasing distance, and/or a size associated with a fetch); a branch predictor (which may implement a branch prediction policy, which may control speculative execution of instructions, such as a level of aggressiveness associated with a prediction); a dispatch unit (which may implement a dispatch policy, such as a simultaneous multithreading (SMT) instruction policy for multithreading and/or a clustering algorithm); a vector unit (which may implement a vector instruction execution policy, such as a fault-first policy); a clock controller (which may implement a clock gating policy, such as for balancing power management and/or execution speed); and the like. The set of parameters may be written to one or more registers implemented by the processor core (e.g., control and/or status register(s)). Writing the set of parameters to the one or more registers may implement characteristics or behaviors of the processor core (e.g., performance, power management, malware response, fault tolerance, and/or application security). Thus, the set of parameters may be used to control the characteristics or behaviors of the processor core for when the processor core executes the process (e.g., on a per process basis).

In some implementations, the process may be identified, the set of parameters may be determined, and/or the component(s) may be configured via software (e.g., by the identified process, and/or by another process, which could be a user level process, a supervisor process, and/or the kernel), by hardware (e.g., by using microcode implemented by the processor core), by firmware, and/or by a combination thereof. In some implementations, a context switch to a process, and/or an address space change associated with a process, may cause the process to be identified, the set of parameters to be determined, and/or the component(s) to be configured. In some implementations, the set of parameters may comprise an opaque data type that is not made available to a user level process. In some implementations, the set of parameters may be written to a register to configure the component(s), such as via a “prctl( )” system call in Linux. In some implementations, the process may be executed within a security domain or context that isolates the set of parameters from processes that are outside of the security domain or context. In some implementations, the process may be associated with a hypervisor (e.g., a virtual machine monitor (VMM) or virtualizer) associated with a virtual machine identifier (VMID). In some implementations, the hypervisor may execute a guest operating system that hosts a guest operating system process, and the first set of parameters may be based on an attribute of the hypervisor, the guest operating system process, and/or a combination thereof.

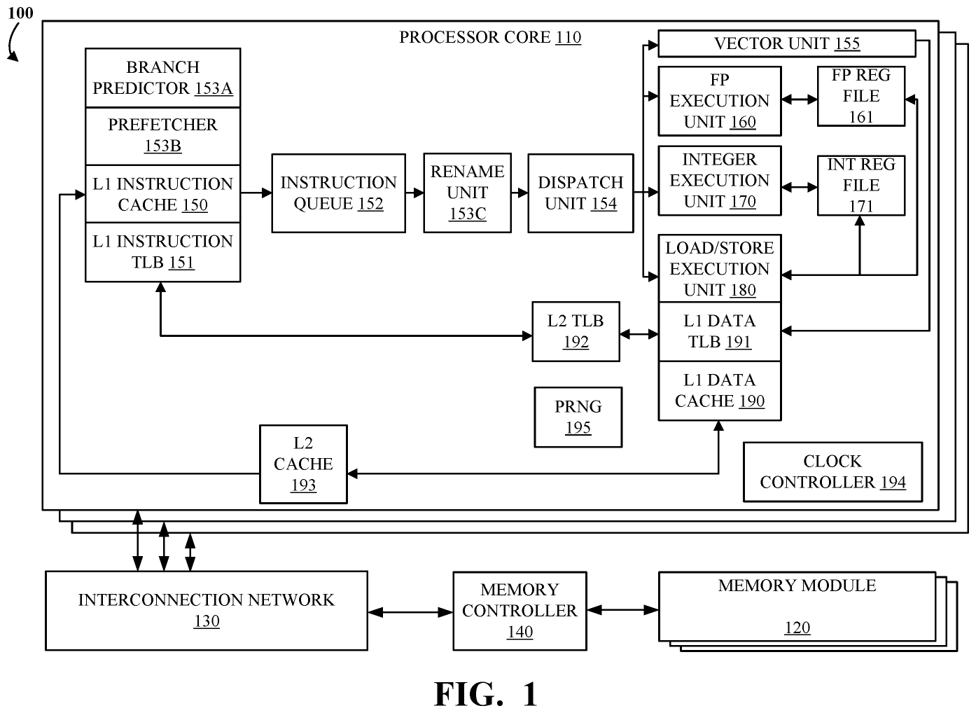

FIG. 1 is a block diagram of an example of a processing system 100 that implements a microarchitecture. The processing system 100 may be configured to decode and execute instructions of an instruction set instruction set architecture (ISA) (e.g., the RISC-V instruction set) in pipelined data paths. The instructions may execute speculatively and out-of-order in the processing system 100. The processing system 100 may be a compute device, a microprocessor, a microcontroller, or a semiconductor intellectual property (IP) core or block. The processing system 100 may be implemented as an integrated circuit, such as in an application specific integrated circuit (ASIC) or a system on a chip (SoC).

The processing system 100 includes at least one processor core 110. The processor core 110 may be implemented using one or more central processing unit (CPUs). Each processor core 110 may be connected to one or more memory modules 120 via an interconnection network 130 and a memory controller 140. The one or more memory modules 120 may be referred to as an external memory, main memory, backing store, coherent memory, or backing structure (collectively “backing structure”). In some implementations, the one or more memory modules 120 may comprise volatile memory, such as dynamic random access memory (DRAM) and/or a static random access memory (SRAM), such as a shared level 3 (L3) cache, and may be further connected to non-volatile memory, such as a disk drive, a solid-state drive, flash memory, and/or phase-change memory (PCM).

Each processor core 110 may implement components of the microarchitecture (e.g., dispatch units, execution units, vector units, registers, caches, queues, data paths, and/or other logic associated with instruction flow, such as prefetchers, branch predictors, clock controllers, and the like, as discussed herein). For example, each processor core 110 can include a level one (L1) instruction cache 150. The L1 instruction cache 150 may be associated with an L1 instruction translation lookaside buffer (TLB) 151, such as for virtual-to-physical address translation. An instruction queue 152, which may be a first in, first out (FIFO) queue, may buffer instructions fetched from the L1 instruction cache 150. The instructions may be fetched according to a branch predictor 153A, a prefetcher 153B, and/or other instruction fetch processing. For example, the branch predictor 153A may implement a branch prediction policy, which may control speculative execution of instructions (e.g., a level of aggressiveness associated with a prediction of instructions to be executed). For example, the prefetcher 153B may implement a prefetch policy, such as a number of streams that the prefetcher will track, a distance associated with a fetch, a window associated with a fetch, allowing a linear to exponentially increasing distance, and/or a size associated with a fetch.

Dequeued instructions (e.g., instructions exiting the instruction queue 152) may be renamed in a rename unit 153C (e.g., to avoid false data dependencies) and then dispatched by a dispatch unit 154 to appropriate backend execution units. The dispatch unit 154 may implement a dispatch policy, such as an SMT instruction policy and/or a clustering algorithm. For example, the dispatch unit 154 may control a number of instructions to be executed by the processor core 110 per clock cycle. The backend execution units may include a vector unit 155. The vector unit 155 may include one or more execution units configured to execute vector instructions (e.g., instructions that operate on multiple data elements at the same time). The vector unit 155 may execute vector instructions according to a vector instruction execution policy, such as a fault-first policy (e.g., fault-first, fault on first, first fault, fail-first, ffirst, and/or the like, may refer to a fault condition which may occur due to incorrectly accessing data associated with a vector instruction). The vector unit 155 may be allocated physical registers in a vector register file. The backend execution units may also include a floating point (FP) execution unit 160, an integer (INT) execution unit, and/or a load/store execution unit 180. The FP execution unit 160, the INT execution unit 170, and the load/store execution unit 180 may be configured to execute scalar instructions (e.g., instructions that operate on one data element at a time). The FP execution unit 160 may be allocated physical registers (e.g., FP registers) in an FP register file 161, and the INT execution unit 170 may be allocated physical registers (e.g., INT registers) in an INT register file 171. The FP register file 161 and the INT register file 171 may also be connected to the load/store execution unit 180. The load/store execution unit 180 and the vector unit 155 may access an L1 data cache 190 via an L1 data TLB 191. The L1 data TLB 191 may be connected to a level two (L2) TLB 192, which in turn may be connected to the L1 instruction TLB 151. The L1 data cache 190 may be connected to an L2 cache 193, which may be connected to the L1 instruction cache 150. In some implementations, the caches (e.g., the L1 instruction cache 150, the L1 data cache 190, and/or the L2 cache 193) may be configured with respect to cache coherence protocols. A clock controller 194, another component, may provide clock signals to circuitry associated with the aforementioned components, including according to a clock gating policy (e.g., clock gating may refer to a technique to reduce dynamic power dissipation of circuits associated with components by removing a clock signal when a circuit is not in use). In some implementations, the clock controller 194 may be used to configure clock signals to control power consumption associated with the component. A pseudorandom number generator (PRNG) 195, another component, may also be implemented in the processor core 110 to provide pseudorandom numbers.

In some implementations, one or more of the components may be configured to implement redundancy associated with executing instructions. For example, components of the processor core 110 (e.g., the dispatch unit 154, the backend execution units, and the like) could implement a synchronization policy that causes instructions to execute in multiple processor cores in the processing system 100 with redundancy (e.g., lockstep execution). In some implementations, the PRNG 195 may be configured to provide a pseudorandom number, such as for a specific process executed by the processor core 110 (e.g., a PRNG seed specific to a process, which could be used to uniquely identify the process in a security context).

The processing system 100 and each component in the processing system 100 is illustrative and can include additional, fewer, or different components which may be similarly or differently architected without departing from the scope of the specification and claims herein. Moreover, the illustrated components can perform other functions without departing from the scope of the specification and claims herein.

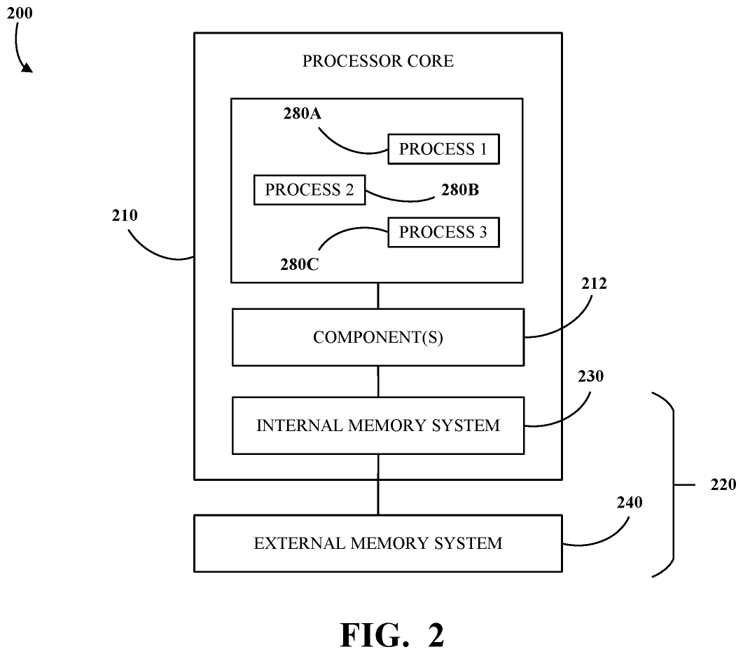

FIG. 2 is a block diagram of an example of a system 200 including a processor core 210 and a memory system 220. The processor core 210 may be like the processor core 110 shown in FIG. 1. The memory system 220 may include an internal memory system 230 and an external memory system 240. The internal memory system 230 may include components like the L1 instruction cache 150, the L1 data cache 190, the L2 cache 193 shown in FIG. 1. The external memory system 240 may include components like the memory modules 120, the interconnection network 130, and the memory controller 140 shown in FIG. 1. The processor core 210 and the memory system 220 may be implemented together in an integrated circuit, such as an ASIC or an SoC.

The processor core 210 may execute processes, such as processes 280A through 280C. The processes 280A through 280C may include operating system processes (e.g., program applications or threads) hosted by an operating system executed by the processor core 210. A kernel of the operating system may be one of the processes. The processes 280A through 280C may execute instructions according to a microarchitecture, such as the microarchitecture implemented by the processor core 110 shown in FIG. 1. The processor core 210 may include one or more configurable component(s) 212 for executing the processes, such as one or more of the branch predictor 153A, the prefetcher 153B, the dispatch unit 154, the vector unit 155, the clock controller 194, and/or other components shown in FIG. 1. For example, the instructions for the processes may be predicted and/or fetched from the memory system 220 according to the component(s) 212. A branch predictor may implement a branch prediction policy which may control speculative execution of instructions to be executed by processes 280A through 280C (e.g., a level of aggressiveness associated with a prediction of instructions to be executed). A prefetcher may implement a prefetch policy which may control a number of streams that the prefetcher will track, a distance associated with a fetch, a window associated with a fetch, allowing a linear to exponentially increasing distance, and/or a size associated with a fetch, for instructions to be executed by processes 280A through 280C.

The processes 280A through 280C, executing in the processor core 210, may have different usage patterns. For example, process 280A may be associated with a web browser and process 280B may be associated with a mathematically intensive program that may be executing many matrix multiplication operations. As a result, the processes 280A and 280B may access the memory system 220 differently than one another. Implementations of this disclosure permit adapting (e.g., configuring) one or more components of the microarchitecture to a specific process (e.g., the process 280A or the process 280B), based on an attribute of the process (e.g., an identifier associated with the process 280A or the process 280B), so as to permit tuning the microarchitecture for the process. For example, the component(s) 212 may be configured in a first manner for the process 280A, then may be configured in a second manner (e.g., re-configured) for the process 280B. This may permit controlling desirable characteristics or behaviors of the processor core 210 as the processor core executes the different processes. The characteristics or behaviors may include, for example, performance (e.g., execution speed), power management, malware response, fault tolerance, and/or application security. For example, components of the processor core 210 may be configured in the first manner for the process 280A (e.g., the web browser), so as to configure the microarchitecture for malware response and/or application security when executing the process 280A, then may be configured in the second manner for the process 280B (e.g., the mathematically intensive program), so as to configure the microarchitecture for performance (e.g., execution speed) when executing the process 280B. As a result, components of the processor core 210 may be configured to implement policies relating to performance, power management, malware response, fault tolerance, and/or application security, on a per process basis, as desired.

In some implementations, a process may be identified, such as the process 280A. Based on an attribute of the identified process (e.g., the process 280A), a set of parameters may be determined for use with the process. The set of parameters may be used to configure one or more components of the processor core 210 for use when executing the process. Thus, the set of parameters may be used to control the characteristics or behaviors of the processor core 210 that may be desired as the processor core executes the process (e.g., the process 280A).

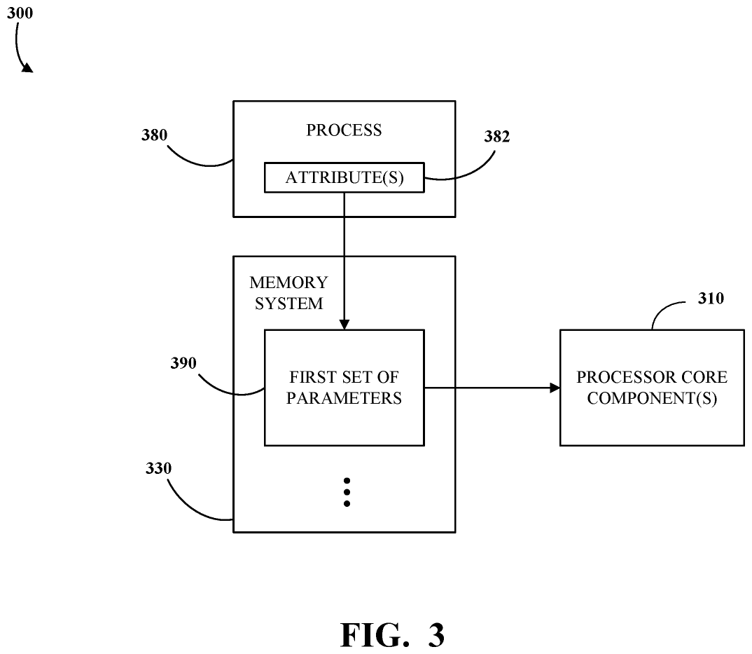

FIG. 3 is a block diagram of an example 300 of configuring one or more components 310 of a processor core on a per process basis. The component(s) 310 may be like the components of the processor core 110 shown in FIG. 1, such as one or more of the branch predictor 153A, the prefetcher 153B, the dispatch unit 154, the vector unit 155, the clock controller 194, and/or other components shown in FIG. 1, and/or like the component(s) 212 shown in FIG. 2.

To configure the component(s) 310 on a per process basis, a process 380 may be identified. The process 380 may be like a process shown in FIG. 2, such as the process 280A or the process 280B. The process 380 may have instructions configured to be executed by a processor core like the processor core 110 shown in FIG. 1 and/or the processor core 210 shown in FIG. 2. In some implementations, the process 380 may be identified based on an attribute 382 of the process 380. For example, the attribute 382 may comprise an identifier, such as an ASID associated with the process 380 (which may be stored in an address space register), an address space stored in a page table base register, a VMID, or a combination thereof.

For example, the ASID may be stored in an ASID register. The ASID may be used to tag valid addresses for the process 380, such as in a TLB. A kernel of the operating system hosting the process 380 may use the ASID to identify the process 380, such as when switching contexts to or from the process 380. In such systems, the ASID may be used as the attribute 382.

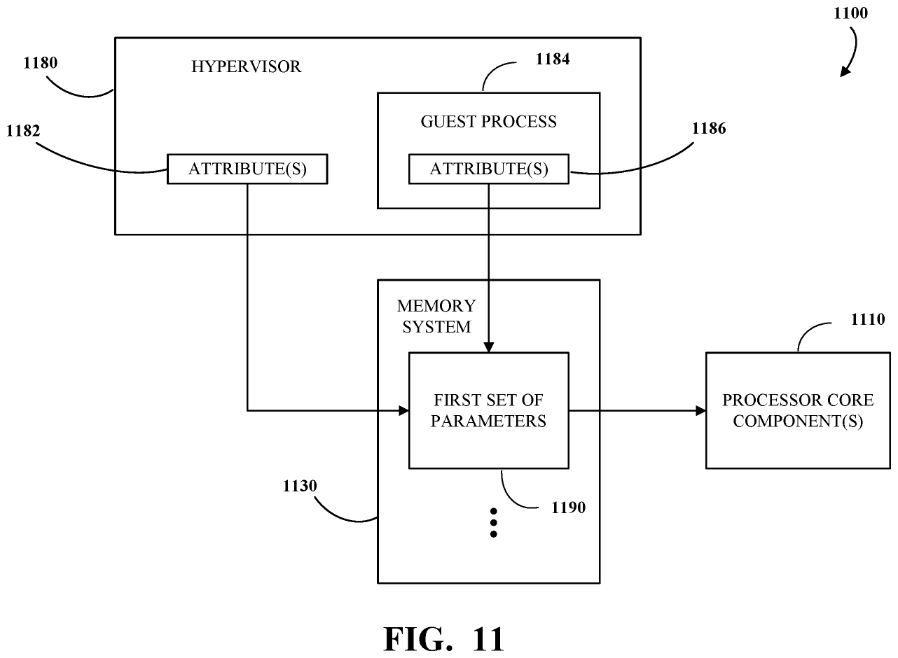

In some cases, the process 380 may be a hypervisor identified by a VMID or may be a process controlled by a hypervisor and the process 380 may be identified based on a combination of a VMID and an ASID, for example. In such cases, a combination of the VMID and the ASID may be used to tag valid addresses for the process 380, such as in a TLB. In such systems, the attribute 382 may be the VMID or a combination of the VMID and the ASID. An example of an implementation that is responsive to a hypervisor is further described in FIG. 11.

Some systems may use an address space stored in a page table base register. The address space may be used to indicate valid addresses for the process 380. A kernel of the operating system hosting the process 380 may use the address space stored in a page table base register (e.g., such as by executing a hash function with respect to the address) to identify the process 380. In such systems, the address space stored in the page table base register may be used as the attribute 382. In some implementations, the attribute 382 may be a range of memory addresses available to the process 380 executing in the processor core. In such implementations, identifying the process 380, such as by the attribute 382, may include detecting the processor core executing to access a memory address within the range of memory addresses. In some implementations, the process 380 may be identified via software (e.g., by the process 380, and/or by another process, which could be a user level process, a supervisor process, and/or the kernel), by hardware (e.g., by using microcode implemented by the processor core), by firmware, and/or by a combination thereof. In some implementations, a context switch to the process 380, and/or an address space change associated with the process 380, may cause the process 380 to be identified.

Based on the attribute 382 of the identified process, a first set of parameters 390 may be determined for use with the process 380 (e.g., metadata). In some implementations, the first set of parameters 390 may be determined via software (e.g., by the process 380, and/or by another process, which could be a user level process, a supervisor process, and/or the kernel), by hardware (e.g., by using microcode implemented by the processor core), by firmware, and/or by a combination thereof. In some implementations, a context switch to the process 380, and/or an address space change associated with the process 380 (e.g., the ASID associated with the process 380 and/or the address space stored in a page table base register), may trigger or cause the first set of parameters 390 to be determined. In some implementations, the first set of parameters 390 may comprise an opaque data type that is not made available to a user level process).

The component(s) 310 of the processor core may be configured using the first set of parameters 390. In some implementations, the component(s) 310 may be configured via software (e.g., by the process 380, and/or by another process, which could be a user level process, a supervisor process, and/or the kernel), by hardware (e.g., by using microcode implemented by the processor core), by firmware, and/or by a combination thereof. In some implementations, a context switch to the process 380, and/or an address space change associated with the process 380, may cause the component(s) 310 to be configured. In some implementations, the first set of parameters 390 may be written to a register associated with the processor core to configure the component(s) 310, such as via a “prctl( )” system call in Linux. Writing the first set of parameters 390 to the register may implement the characteristics or behaviors of the processor core as the processor core executes the process 380 (e.g., performance, power management, malware response, fault tolerance, and/or application security).

In some implementations, the process 380 may be executed within a security domain or context that isolates the first set of parameters 390 from processes that are outside of the security domain or context (e.g., the process 380 may be like the process 280A shown in FIG. 2, which may be executed within a security domain or context that isolates the first set of parameters 390 from a process that is outside of the security domain or context, like the process 280B shown in FIG. 2). Thus, the first set of parameters 390 may be used to configure the component(s) 310 to control one or more of the characteristics or behaviors of the processor core as the processor core executes the process 380 while preventing some or all other processes from modifying and/or viewing the parameters for the process 380. For example, the first set of parameters 390 may be stored in a memory space configured to be accessible by the process 380 and not be accessible from one or more other processes. This may permit configuring secure configuration of the microarchitecture of the processor core to control characteristics such as performance (e.g., execution speed), power management, malware response, fault tolerance, and/or application security.

In some implementations, configuring the component(s) 310 for performance (e.g., execution speed) could comprise, for example, configuring a clock controller (e.g., like the clock controller 194 shown in FIG. 1) to increase frequency and/or to reduce latency. Configuring the component(s) 310 for power management could comprise, for example, configuring a clock controller (e.g., like the clock controller 194 shown in FIG. 1) to implement a clock gating policy (e.g., configuring a clock signal to control power consumption associated with a component, such as by selectively removing the clock signal when a component is not in use).

Configuring the component(s) 310 for malware response could comprise, for example, configuring a branch predictor (e.g., like the branch predictor 153A shown in FIG. 1) to remove or re-configure (e.g., to reduce) speculative execution, and/or configuring a vector unit (e.g., like the vector unit 155 shown in FIG. 1) to change a fault-first policy. This may permit operating in a way that is less speculative and more resistant to attack. For example, vector instructions may be provided to allow vectorization of loops whose lengths are unknown, such as by speculatively fetching for future loop iterations. In some cases, it may be possible for a process to use vector instructions to determine whether a portion of memory is inaccessible without the operating system faulting and/or terminating the process, such as according to a fault-first policy implemented by the vector unit 155. This may cause a potential security concern (e.g., testing addresses). As a result, when a process is associated with malware, the fault-first policy implemented by the vector unit 155 may be changed to modulate the extent to which vector instructions may access memory without faulting. For example, a process associated with malware might not be allowed to use vector instructions to access memory without faulting, and/or may be limited by the extent to which vector instructions may access memory without faulting, regardless of a possible performance loss.

Configuring the component(s) 310 for fault tolerance could comprise, for example, configuring a dispatch unit and backend execution units (e.g., like the dispatch unit 154 and the backend execution units shown in FIG. 1) to implement a synchronization policy that causes instructions to execute in the processing core in lockstep with instructions that execute in another processing core in the processing system 100.

Configuring the component(s) 310 for application security could comprise, for example, configuring registers (e.g., like physical registers of the FP register file 161 and/or the INT register file 171 shown in FIG. 1), caches (e.g., like the L1 instruction cache 150, the L1 data cache 190, and/or the L2 cache 193 shown in FIG. 1), and/or the like, to clear and/or isolate memory and/or registers between processes executing in the processor core, and/or configuring a PRNG generator (e.g., like the PRNG generator 195 shown in FIG. 1) to provide a pseudorandom number using a seed that is different on a process-by-process basis.

In some implementations, the first set of parameters 390 may be cached in a memory system 330 associated with the processor core (e.g., the first set of parameters 390 may be cached set of parameters). In one example, the first set of parameters 390 may be cached in a memory system like the internal memory system 230 shown in FIG. 2 (e.g., cached in a hardware component). For example, the first set of parameters 390 may be cached in the L1 data cache 190 and/or the L2 cache 193 shown in FIG. 1. In another example, the first set of parameters 390 may be cached in software (e.g., cached in a software component). For example, the first set of parameters 390 may be cached in a page cache in main memory (e.g., which may be part of the external memory system 240 shown in FIG. 2), such as a disk cache. The page cache may be managed by a kernel of the operating system hosting the process 380.

In some implementations, the attribute 382 may be an ASID. In such implementations, determining the first set of parameters 390 may include accessing a table comprising multiple parameters (e.g., metadata for controlling the processor core under various conditions, such as when executing certain processes), such as in the memory system 330. For example, the ASID may be used to determine the first set of parameters 390 from multiple parameters in the table. In some implementations, the attribute 382 may be an address space stored in a page table base register implemented by the processor core. In such implementations, determining the first set of parameters 390 may include accessing a table comprising multiple parameters, such as in the memory system 330. For example, the page table base register may be used to determine the first set of parameters 390 from the multiple parameters in the table.

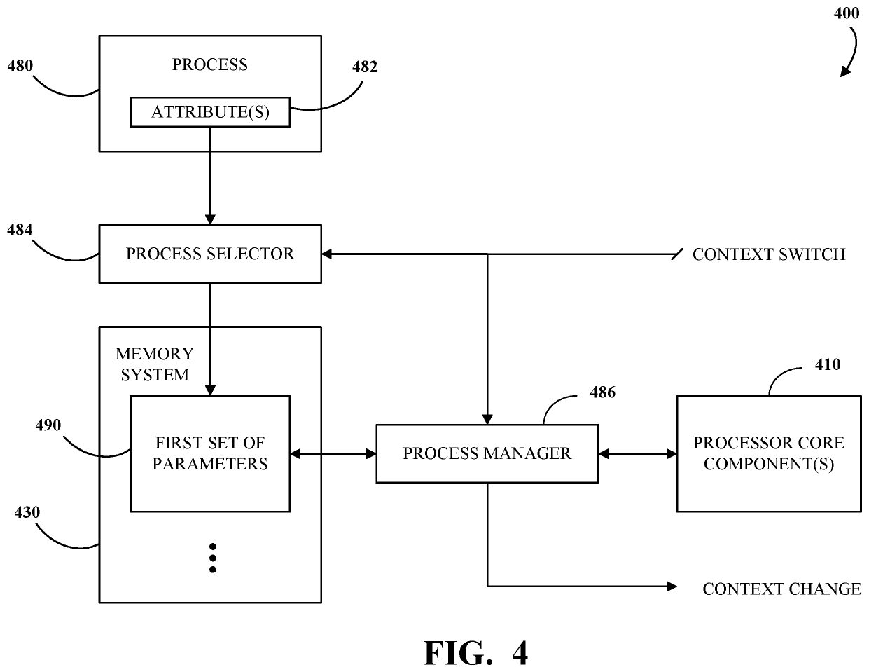

FIG. 4 is an example 400 of configuring one or more components 410 of a processor core on a per process basis, such as for a process 480. For example, the process 480 may be a process such as the process 380 shown in FIG. 3 or the process 280A shown in FIG. 2. For example, the process 480 may be identified by an attribute 482 like the attribute 382 shown in FIG. 3. The component(s) 410 may be like the components of the processor core 110 shown in FIG. 1, such as one or more of the branch predictor 153A, the prefetcher 153B, the dispatch unit 154, the vector unit 155, the clock controller 194, and/or other components shown in FIG. 1, and/or like the component(s) 212 shown in FIG. 2.

To configure the component(s) 310 on a per process basis, the process 480 may be identified. The process 480 may be identified by a process selector 484. Identifying the process 480, such as by the attribute 482, may include the process selector 484 detecting the processor core executing to access a memory address within a given range of memory addresses (e.g., associated with the process 480). In some implementations, the process selector 484 may comprise software, such as a second process (e.g., a process that is different than the process 480), like the process 280B shown in FIG. 2. In some implementations, the process selector 484 may be part of the process 480. In some implementations, the process selector 484 may comprise hardware, which may include using microcode implemented by the processor core. In some implementations, the process selector 484 may detect a context switch to the process 480 (e.g., from a prior executing process, like the process 280C shown in FIG. 2), and/or the process selector 484 may detect an address space change associated with the process 480. The process 480 may be identified responsive to the detection (e.g., responsive to the context switch). In some implementations, the process 480 may be a process executing in a user mode, and the process selector 484 may be a process executing in a privileged mode. In such implementations, identifying the process 480 may involve using the process selector 484 to identify the process 480.

Based on the attribute 482 of the identified process, a first set of parameters 490 may be determined for use with the process 480, like the first set of parameters 390 shown in FIG. 3. The first set of parameters 490 may be determined by the process selector 484. In some implementations, the first set of parameters 490 may be determined via software (e.g., by the process 480, like the process 280A shown in FIG. 2, and/or by a second process, like the process 280B shown in FIG. 2), by hardware (e.g., by using microcode implemented by the processor core), by firmware, and/or by a combination thereof. In some implementations, detecting a context switch to the process 480, and/or detecting an address space change associated with the process 480, may cause the process selector 484 to determine the first set of parameters 490. In some implementations, the first set of parameters 490 may be stored in a memory system 430 like the memory system 330 shown in FIG. 3. In some implementations, the first set of parameters 490 may comprise an opaque data type that is not made available to a user level process). In some implementations, the process selector 484 detecting a context switch to the process 480 (e.g., from a prior executing process, like the process 280C shown in FIG. 2), and/or the process selector 484 detecting an address space change associated with the process 480, may cause the process selector 484 to determine the first set of parameters 490 (e.g., responsive to the context switch). In some implementations, the process 480 may be a process executing in a user mode, and the process selector 484 may be a process executing in a privileged mode. In such implementations, determining the first set of parameters 490 may involve using the process selector 484, executing in the privileged mode, to determine the first set of parameters 490 (as opposed to using a process in the user mode, like the process 480).

The component(s) 410 of the processor core may be configured using the first set of parameters 490. The component(s) 410 may be configured by a process manager 486. In some implementations, the process manager 486 may be part of the process selector 484. In some implementations, the process manager 486 may comprise software, such as a second process (e.g., a process that is different than the process 480), like the process 280B shown in FIG. 2. In some implementations, the process manager 486 may be part of the process 480. In some implementations, the process manager 486 may comprise hardware, which may include using microcode implemented by the processor core. In some implementations, the process manager 486 detecting a context switch to the process 480 (e.g., from a prior executing process, like the process 280C shown in FIG. 2), and/or the process manager 486 detecting an address space change associated with the process 480, may cause the process manager 486 to configure the component(s) 410 (e.g., responsive to the context switch). In some implementations, the process manager 486 may execute the context switch. For example, the process manager 486 could be a kernel of the operating system hosting the process 480. In some implementations, the process manager 486 may write the first set of parameters 490 to a register associated with the processor core to configure the component(s) 410, such as via a “prctl( )” system call in Linux. In some implementations, the process 480 may be a process executing in a user mode, and the process selector 484 may be a process executing in a privileged mode. In such implementations, configuring the component(s) 410 may involve using the process manager 486, executing in the privileged mode, to configure the component(s) 410, such as by writing the first set of parameters 490 to the register (as opposed to using a process in the user mode, like the process 480).

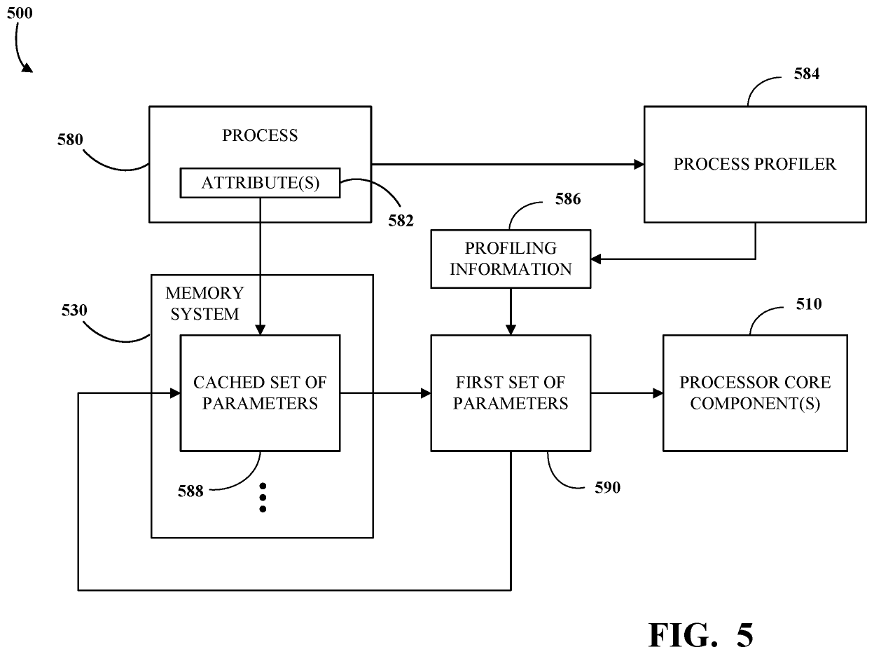

FIG. 5 is an example 500 of configuring one or more components 510 of a processor core on a per process basis, such as for a process 580. For example, the process 480 may be a process such as the process 380 shown in FIG. 3 or the process 280A shown in FIG. 2. For example, the process 580 may be identified by an attribute 582 like the attribute 382 shown in FIG. 3. The component(s) 510 may be like the components of the processor core 110 shown in FIG. 1, such as one or more of the branch predictor 153A, the prefetcher 153B, the dispatch unit 154, the vector unit 155, the clock controller 194, and/or other components shown in FIG. 1, and/or like the component(s) 212 shown in FIG. 2.

A process profiler 584 may obtain profiling information 586. The profiling information 586 may characterize execution of the process 580 by the processor core (e.g., learning usage patterns associated with the process). For example, the process profiler 584 may monitor execution of the process 580 (e.g., collect data) to obtain the profiling information 586. In some implementations, the process profiler 584 may comprise software, such as a second process (e.g., a process that is different than the process 580), like the process 280B shown in FIG. 2. In some implementations, the process profiler 584 may be part of the process 580. In some implementations, the process profiler 584 may comprise hardware, which may include using microcode implemented by the processor core. In some implementations, the process 480 may be a process executing in a user mode, and the process profiler 584 may be a process executing in a privileged mode. In some implementations, obtaining the profiling information 586 may involve using the process profiler 584 executing in the privileged mode (as opposed to using a process in the user mode, like the process 580). In some implementations, the process profiler 584 may be implemented by a process selector and/or a process manager like the process selector 484 and/or a process manager 486 shown in FIG. 4. The profiling information 586 may be used to determine the first set of parameters 590 (e.g., the profiling information 586 may comprise learned usage patterns associated with the process 580 which may be used to determine the first set of parameters 590). The first set of parameters 590 may then be used to configure the component(s) 510. Thus, in some implementations, the first set of parameters 590 may be determined dynamically, such as by learning the first set of parameters 590 while executing the process 580 (e.g., collecting the profiling information 586 associated with the process 580).

In some implementations, a cached set of parameters 588 may be obtained from a memory system 530 that is like the memory system 330 shown in FIG. 3. For example, the cached set of parameters 588 may be determined via software (e.g., by the process 580, and/or by another process, which could be a user level process, a supervisor process, and/or the kernel), hardware (e.g., by using microcode implemented by the processor core), by firmware, and/or by a combination thereof. In some implementations, the cached set of parameters 588 may be determined based on the profiling information 586. The cached set of parameters 588 may be updated to produce the first set of parameters 590 (e.g., the first set of parameters 590 may comprises changes to the cached set of parameters 588). In some implementations, the cached set of parameters 588 may be changed based on the profiling information 586 to obtain the first set of parameters 590. The component(s) 510 may then be configured using the first set of parameters 590, based on the profiling information 586. In some implementations, the first set of parameters 590, as updated from the cached set of parameters 588, may be stored back in the memory system 530. In some implementations, storing the first set of parameters 590 back in the memory system 530 may comprise overwriting the cached set of parameters 588 in the memory system 530 (e.g., the first set of parameters 590 may overwrite the cached set of parameters 588 to become a new cached set of parameters, updated for the process 580). In some implementations, storing the first set of parameters 590 back in the memory system 530 may comprise adding to the cached set of parameters 588 in the memory system 630 (e.g., creating a second cached set of parameters).

The profiling information 586 associated with the process 580 may be used to permit adapting (e.g., configuring) the component(s) 510 for the process 580, based on the attribute 582 (e.g., tuning the microarchitecture based on the process 580). This may permit controlling, for example, characteristics or behaviors of the processor core as the processor core executes the process 580, such as performance (e.g., execution speed), power management, malware response, fault tolerance, and/or application security, as desired. For example, in some implementations, the profiling information 586 may be used to determine whether the process 580 comprises malware. Based on the profiling information, the first set of parameters 590 may be determined to configure the component(s) 510, such as to include a malware response characteristic or to not include a malware response characteristic. For example, configuring the component(s) 510 to include a malware response characteristic could comprise, for example, configuring a branch predictor (e.g., like the branch predictor 153A shown in FIG. 1) to remove or re-configure (e.g., to reduce) speculative execution, configuring a vector unit (e.g., like the vector unit 155 shown in FIG. 1) to change a fault-first policy, and so forth.

In some implementations, the process profiler 584 may make one or more predictions when characterizing the execution of the process 580 to produce the profiling information 586 (e.g., the profiling information 586 may include predictions). For example, in some implementations, the profiling information 586 may include predictions as to whether the process 580 will cause an error in the processor core. For example, in some implementations, the profiling information 586 may include predictions as to whether the process 580 comprises malware. Accordingly, in such implementations, determining the first set of parameters 590 may be based on a prediction.

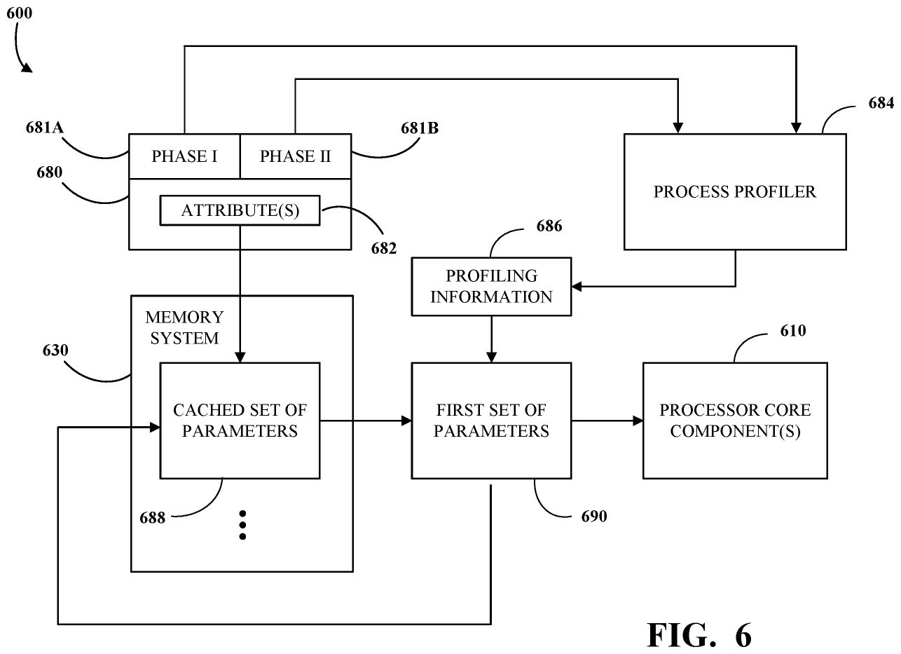

FIG. 6 is an example 600 of configuring one or more components 610 of a processor core on a per process basis, such as for a process 680. For example, the process 680 may be a process such as the process 380 shown in FIG. 3 or the process 280A shown in FIG. 2. For example, the process 680 may be identified by an attribute 682 like the attribute 382 shown in FIG. 3. The component(s) 610 may be like the components of the processor core 110 shown in FIG. 1, such as one or more of the branch predictor 153A, the prefetcher 153B, the dispatch unit 154, the vector unit 155, the clock controller 194, and/or other components shown in FIG. 1, and/or like the component(s) 212 shown in FIG. 2.

The process 680 may go through different operational phases during its execution by the processor core, such as phases 681A and 681B (e.g., the process 680 may behave differently at different times during its own execution, as reflected by the phases). For example, the phase 681A may involve relatively more memory accesses to a memory system 630 (e.g., which may be associated with a data gathering phase or an input phase), and the phase 681B may involve relatively fewer memory accesses to the memory system 630 (e.g., which may be associated with a data processing phase or an output phase). The memory system 630 may be like the memory system 330 shown in FIG. 3. Implementations of this disclosure permit adapting the component(s) 610 based on the phase associated with the process 680 (e.g., the phases 681A or 681B). For example, various policies with respect to performance (e.g., execution speed), power management, malware response, fault tolerance, and/or application security, may be applied based on the current phase of the process being executed.

A process profiler 684 may identify a change in phase associated with the process 680. For example, the change in phase may be associated with transitioning from the phase 681A to the phase 681B. In some implementations, the phase and/or the change in the phase may be identified by evaluating a program counter (PC) associated with the processor core (e.g., a hash function may be applied to the PC, which may generate a signature that may be used as an index to table for indicating the phase, such as a PC within a given range corresponding to a given phase). In some implementations, the process profiler 684 may obtain profiling information 686 based on the phase. The profiling information 686 may characterize execution of the phase by the processor core. For example, the process profiler 684 may monitor execution of the phase 681A (e.g., collect data) to obtain the profiling information 686 during a first time period. The profiling information 686 may be used to determine the first set of parameters 690, which may be used to configure the component(s) 610 during the first time period. The process profiler 684 may then identify a change from the phase 681A to the phase 681B. The process profiler 684 may monitor execution of the phase 681B (e.g., collect data) to update the profiling information 686 during a second time period. The updated profiling information 686 may be used to update the first set of parameters 690, which may be used to configure the component(s) 610 during the second time period (e.g., re-configure the component(s) 610). In some implementations, the first set of parameters 690 may be determined dynamically, such as by learning the first set of parameters 690 while executing phases of the process 680 (e.g., collecting the profiling information 686 associated with a phase).

In some implementations, a cached set of parameters 688 may be obtained from a memory system 630. For example, the cached set of parameters 688 may be determined via software (e.g., by the process 680, and/or by another process, which could be a user level process, a supervisor process, and/or the kernel), by hardware (e.g., by using microcode implemented by the processor core), by firmware, and/or by a combination thereof. In some implementations, the cached set of parameters 688 may be determined based on the profiling information 686, including based on the phase of execution of the process 680 (e.g., the phase 681A or the phase 681B). The cached set of parameters 688 may be used to determine the first set of parameters 690 for a given phase. In some implementations, the cached set of parameters 688 may be changed based on the profiling information 686 to obtain the first set of parameters 690. The component(s) 610 may then be configured using the first set of parameters 690, based on the profiling information 686. In some implementations, the first set of parameters 690 for a given phase, updated from the cached set of parameters 688, may be stored back in the memory system 630. In some implementations, storing the first set of parameters 690 back in the memory system 630 may comprise overwriting the cached set of parameters 688 in the memory system 630. In some implementations, storing the first set of parameters 690 back in the memory system 630 may comprise adding to the cached set of parameters 688 in the memory system 630 (e.g., creating a second cached set of parameters).

The profiling information 686 associated with the phase may be used to permit adapting (e.g., configuring) the component(s) 610 on a per phase basis (e.g., tuning the microarchitecture based on the phase of the process 680). This may permit controlling, for example, characteristics or behaviors of the processor core as it executes a phase, such as performance (e.g., execution speed), power management, malware response, fault tolerance, and/or application security, as desired. For example, in some implementations, the profiling information 686 may be used to determine whether the phases 681A and/or 681B comprise malware. Based on the profiling information 686, the first set of parameters 690 may be determined to treat the phases 681A and/or 681B differently. For example, the first set of parameters 690 may be determined to configure the component(s) 610 to not include a malware response characteristic when executing the phase 681A, then to include a malware response characteristic when executing the phase 681B. This could occur, for example, when executing a process in the processor core that is later determined to comprise malware.

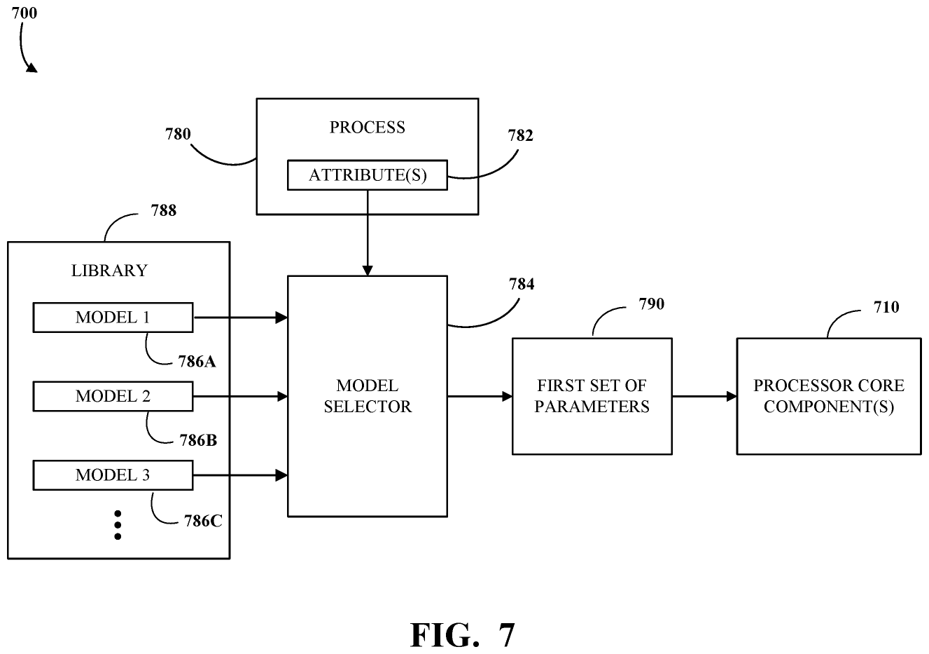

FIG. 7 is an example 700 of configuring one or more components 710 of a processor core on a per process basis, such as for a process 780. For example, the process 780 may be a process such as the process 380 shown in FIG. 3 or the process 280A shown in FIG. 2. For example, the process 780 may be identified by an attribute 782 like the attribute 382 shown in FIG. 3. The component(s) 710 may be like the components of the processor core 110 shown in FIG. 1, such as one or more of the branch predictor 153A, the prefetcher 153B, the dispatch unit 154, the vector unit 155, the clock controller 194, and/or other components shown in FIG. 1, and/or like the component(s) 212 shown in FIG. 2.

A model selector 784 may evaluate models in a library 788, such as models 786A through 786C. In some implementations, the model selector 784 may comprise software, such as a second process (e.g., a process that is different than the process 780), like the process 280B shown in FIG. 2. In some implementations, the model selector 784 may be part of the process 780. In some implementations, the model selector 784 may comprise hardware, which may include using microcode implemented by the processor core. In some implementations, the model selector 784 may comprise a combination of hardware and software. The model selector 784 may select a model from the library 788, such as the model 786A (e.g., “model 1”). The model selector 784 may evaluate one or more of the models (e.g., the models 786A through 786C) in the library 788 to determine the particular model (e.g., the model 786A) for the process 780. For example, the model selector 784 may select the model (e.g., the model 786A) based on the attribute 782, such as by using an ASID associated with the process 780 being used to select the model, an address space stored in a page table base register, a VMID, or a combination thereof. The model that is selected may specify a first set of parameters 790 to use for the process 780. The first set of parameters 790 may then be used to configure the component(s) 710. Thus, a model may be selected to adapt (e.g., configure) the component(s) 710 based on the attribute 782 (e.g., tuning the microarchitecture based on the process 780). This may permit controlling, for example, characteristics or behaviors of the processor core, based on the model, as it executes the process 780, such as performance (e.g., execution speed), power management, malware response, fault tolerance, and/or application security, on a per process basis, as desired.

In some implementations, the models (e.g., the models 786A through 786C) in the library 788 may comprise parameters that are targeted to control characteristics or behaviors in certain ways. For example, a first model (e.g., the model 786A) may be a performance model that configures the component(s) 710 to increase execution speed and/or reduce latency (e.g., specifying parameters); a second model (e.g., the model 786B) may be a power management model that configures the component(s) 710 to reduce power consumption; a third model (e.g., the model 786C) may be a malware response model that configures the component(s) 710 to increase protection of the system; a fourth model may be a fault tolerance model that configures the component(s) 710 to execute with redundancy; a fifth model may be an application security model that configures the component(s) 710 to increase security between processes; and so forth. It should be appreciated that the component(s) 710 may be tuned in a combination of ways, which may balance tradeoffs between different characteristics or behaviors. As a result, many different models may be created as desired, including custom models and models implementing machine learning to dynamically update.

In some implementations, the process 780 may be executed within a security domain or context that isolates the selected model specifying the first set of parameters 790 (e.g., the model 786A) from processes that are outside of the security domain or context. For example, the process 780, which may be like the process 280A shown in FIG. 2, may be executed within a security domain or context that isolates the model 786A, and/or the first set of parameters 790 specified by the model 786A, from the process 280B shown in FIG. 2 that is outside of the security domain or context. This may prevent processes that are outside of the security domain or context (e.g., the process 280B) from accessing the model (e.g., the model 786A, used by the process 780, which may be like the process 280A).

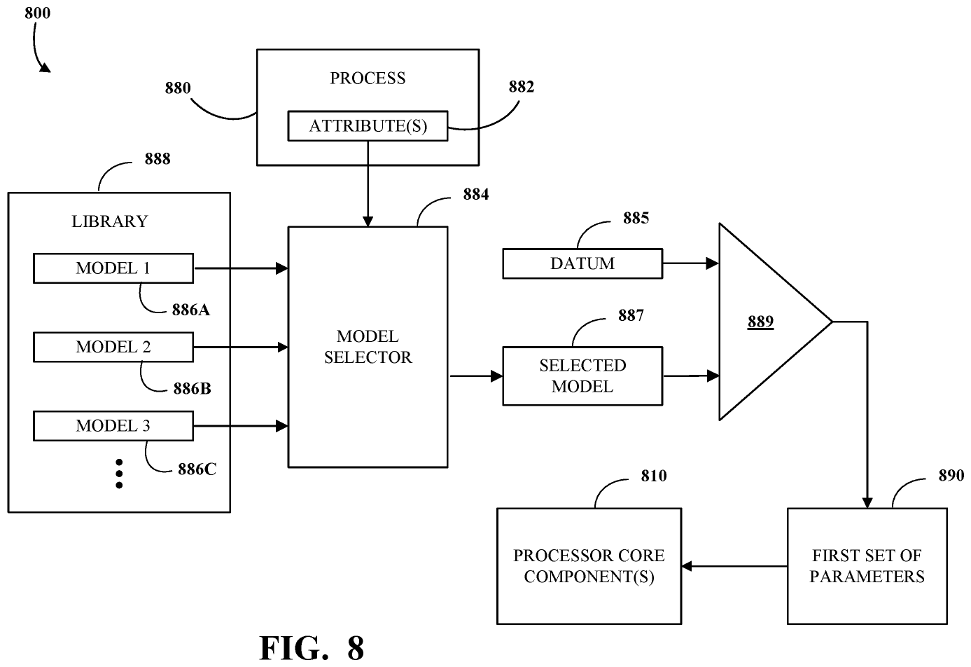

FIG. 8 is an example 800 of configuring one or more components 810 of a processor core on a per process basis, such as for a process 880. For example, the process 880 may be a process such as the process 380 shown in FIG. 3 or the process 280A shown in FIG. 2. For example, the process 880 may be identified by an attribute 882 like the attribute 382 shown in FIG. 3. The component(s) 810 may be like the components of the processor core 110 shown in FIG. 1, such as one or more of the branch predictor 153A, the prefetcher 153B, the dispatch unit 154, the vector unit 155, the clock controller 194, and/or other components shown in FIG. 1, and/or like the component(s) 212 shown in FIG. 2.

A model selector 884 may evaluate models in a library 888, such as models 886A through 886C. In some implementations, the model selector 884 may comprise software, such as a second process (e.g., a process that is different than the process 880), like the process 280B shown in FIG. 2. In some implementations, the model selector 884 may be part of the process 880. In some implementations, the model selector 884 may comprise hardware, which may include using microcode implemented by the processor core. In some implementations, the model selector 884 may comprise a combination of hardware and software. The model selector 884 may select a model from the library 888, such as the model 886A (e.g., “model 1”). The model selector 884 may evaluate one or more of the models (e.g., the models 886A through 886C) in the library 888 to select the particular model (e.g., the model 886A) for the process 880. For example, the model selector 884 may select the model (e.g., the model 886A) based on the attribute 882, such as by using an ASID associated with the process 880 to select the model, an address space stored in a page table base register, a VMID, or a combination thereof. The model that is selected (e.g., a selected model 887) may be compared against a datum 885 that may be stored in a memory system associated with the processor core, like the memory system 330 shown in FIG. 3. In some implementations, the datum may represent a characteristic of the processor core, such as profiling information determined with respect to the processor core (e.g., like the profiling information 586 shown in FIG. 5 and/or the profiling information 686 shown in FIG. 6).

The selected model 887 may specify an initial set of parameters. The selected model 887 may be compared against the datum 885 by a comparator 889. In some implementations, the comparator 889 may be part of the process 880. In some implementations, the comparator 889 may comprise hardware, which may include microcode implemented by the processor core. In some implementations, the comparator 889 may comprise a combination of hardware and software. Comparing the selected model 887 against the datum 885 may permit determining a first set of parameters 890 (e.g., from the initial set of parameters specified in the selected model 887) to use for the process 880. The first set of parameters 790 may then be used to configure the component(s) 810. Thus, a model may be selected and updated to adapt (e.g., configure) the component(s) 810 based on the attribute 882 and/or the datum 885 (e.g., tuning the microarchitecture based on the process 880 and a characteristic associated with the process 880). This may permit controlling, for example, characteristics or behaviors of the processor core, based on the model, as it executes the process 880, such as performance (e.g., execution speed), power management, malware response, fault tolerance, and/or application security, on a per process basis, as desired.

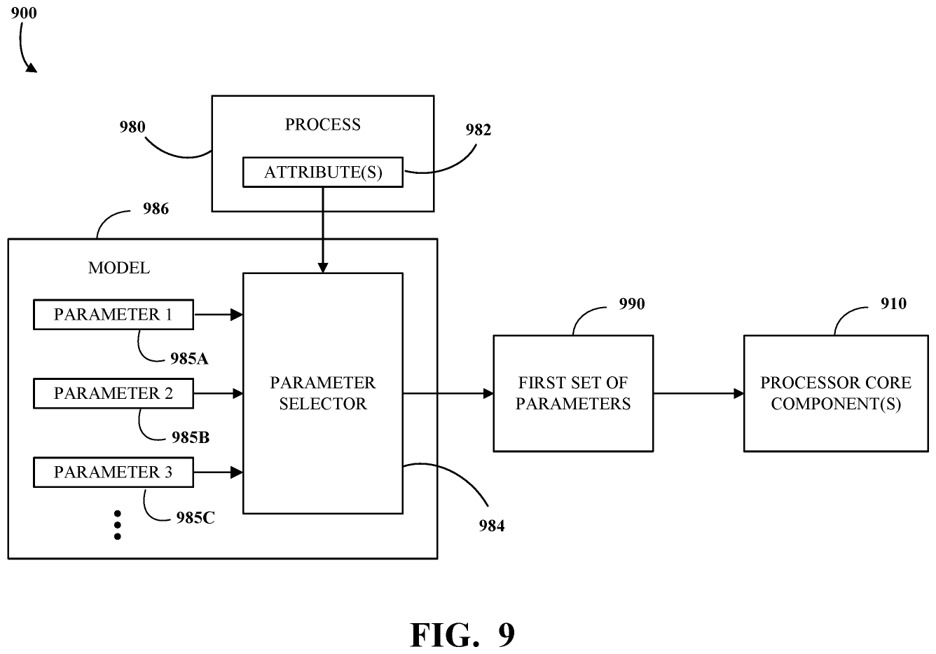

FIG. 9 is an example 900 of configuring one or more components 910 of a processor core on a per process basis, such as for a process 980. For example, the process 980 may be a process such as the process 380 shown in FIG. 3 or the process 280A shown in FIG. 2. For example, the process 980 may be identified by an attribute 982 like the attribute 382 shown in FIG. 3. The component(s) 910 may be like the components of the processor core 110 shown in FIG. 1, such as one or more of the branch predictor 153A, the prefetcher 153B, the dispatch unit 154, the vector unit 155, the clock controller 194, and/or other components shown in FIG. 1, and/or like the component(s) 212 shown in FIG. 2.

A parameter selector 984 may evaluate parameters in a model 986, such as parameters 985A through 985C. In some implementations, the parameter selector 984 may comprise software, such as a second process (e.g., a process that is different than the process 980), like the process 280B shown in FIG. 2. In some implementations, the parameter selector 984 may be part of the process 980. In some implementations, the parameter selector 984 may comprise hardware, which may include microcode implemented by the processor core. In some implementations, the parameter selector 984 may comprise a combination of hardware and software. The model 986 may be like one of the models 786A through 786C shown in FIG. 7. The parameter selector 984 may select parameters from the model 986, such as the parameters 985A and 985C (e.g., “parameter 1” and “parameter 3”) and not the parameter 985B (e.g., “parameter 2”). The parameter selector 984 may evaluate one or more of the parameters (e.g., the parameters 985A through 985C) in the model 986 to select the particular parameters (e.g., the parameters 985A and 985C, and not the parameter 985B) for the process 980. For example, the parameter selector 984 may select the parameters (e.g., the parameters 985A and 985C) based on the attribute 982, such as by using an ASID associated with the process 980 to select the parameters (e.g., the process 980 may be input to the model 986, such as by inputting the ASID associated with the process 980), an address space stored in a page table base register, a VMID, or a combination thereof. The parameters that are selected may comprise a first set of parameters 990 to use for the process 980. The first set of parameters 990 may then be used to configure the component(s) 910. Thus, various individual parameters may be selected from the model 986 to adapt (e.g., configure) the component(s) 910 based on the attribute 982 (e.g., tuning the microarchitecture based on the process 980). This may permit controlling, for example, characteristics or behaviors of the processor core, based on the model, as it executes the process 980. For example, this may permit controlling characteristics or behaviors such as performance (e.g., execution speed), power management, malware response, fault tolerance, and/or application security, on a per process basis, as desired.

In some implementations, the model 986 may be configured to permit control of many different characteristics or behaviors, such as performance (e.g., execution speed), power management, malware response, fault tolerance, application security, and/or a combination thereof, based on the parameters that are selected. For example, the parameters (e.g., the parameters 985A through 985C) may be selected from the model 986 to control the particular characteristics or behaviors that are available in the model as desired.

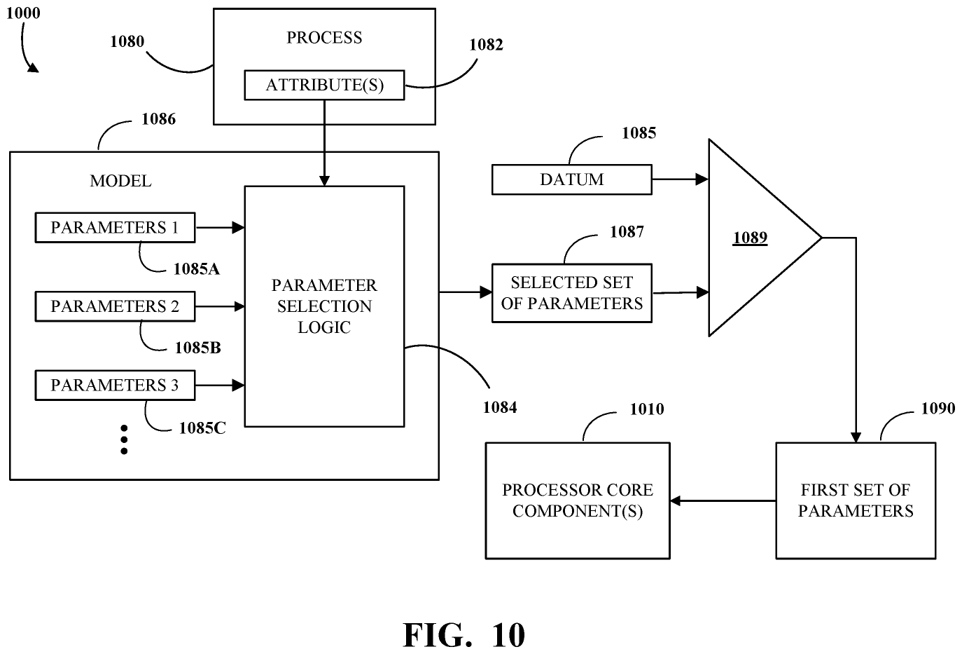

FIG. 10 is an example 1000 of configuring one or more components 1010 of a processor core on a per process basis, such as for a process 1080. For example, the process 1080 may be a process such as the process 380 shown in FIG. 3 or the process 280A shown in FIG. 2. For example, the process 1080 may be identified by an attribute 1082 like the attribute 382 shown in FIG. 3. The component(s) 1010 may be like the components of the processor core 110 shown in FIG. 1, such as one or more of the branch predictor 153A, the prefetcher 153B, the dispatch unit 154, the vector unit 155, the clock controller 194, and/or other components shown in FIG. 1, and/or like the component(s) 212 shown in FIG. 2.

A parameter selector 1084 may evaluate parameters in a model 1086, such as parameters 1085A through 1085C. In some implementations, the parameter selector 1084 may comprise software, such as a second process (e.g., a process that is different than the process 1080), like the process 280B shown in FIG. 2. In some implementations, the parameter selector 1084 may be part of the process 1080. In some implementations, the parameter selector 1084 may comprise hardware, which may include microcode implemented by the processor core. In some implementations, the parameter selector 1084 may comprise a combination of hardware and software. The model 1086 may be like one of the models 786A through 786C shown in FIG. 7. The parameter selector 1084 may evaluate one or more of the parameters (e.g., the parameters 1085A through 1085C) in the model 1086 to select the particular parameters (e.g., the parameters 1085A and 1085C, and not the parameter 1085B) for the process 1080. For example, the parameter selector 1084 may select the parameters (e.g., the parameters 1085A and 1085C) based on the attribute 1082, such as by using an ASID associated with the process 1080 to select the parameters (e.g., the process 1080 may be input to the model 1086, such as by inputting the ASID associated with the process 1080), an address space stored in a page table base register, a VMID, or a combination thereof. The parameters that are selected (e.g., a selected set of parameters 1087) may be compared against a datum 1085 that may be stored in a memory system associated with the processor core, like the memory system 330 shown in FIG. 3. In some implementations, the datum may represent characteristic of the processor core, such as profiling information determined with respect to the processor core (e.g., like the profiling information 586 shown in FIG. 5 and/or the profiling information 686 shown in FIG. 6). The selected set of parameters 1087 may specify an initial set of parameters.

The selected set of parameters 1087 may be compared against the datum 1085 by a comparator 1089. In some implementations, the comparator 1089 may be part of the process 1080. In some implementations, the comparator 1089 may comprise hardware, which may include microcode implemented by the processor core. In some implementations, the comparator 1089 may comprise a combination of hardware and software. Comparing the selected set of parameters 1087 against the datum 1085 may permit determining a first set of parameters 1090 (e.g., from the selected set of parameters 1087) to use for the process 1080. The first set of parameters 1090 may then be used to configure the component(s) 1010. Thus, various individual parameters may be initially selected and kept or updated to adapt (e.g., configure) the component(s) 1010 based on the attribute 1082 and/or the datum 1085 (e.g., tuning the microarchitecture based on the process 1080). This may permit controlling, for example, characteristics or behaviors of the processor core, based on the model, as it executes the process 980, such as performance (e.g., execution speed), power management, malware response, fault tolerance, and/or application security, on a per process basis, as desired

FIG. 11 is an example 1100 of configuring one or more components 1110 of a processor core on a per process basis. A hypervisor 1180 may be executed as a process or similar to a process such as the process 380 shown in FIG. 3 or the process 280A shown in FIG. 2. In some implementations, the hypervisor 1180 is a virtual machine monitor (VMM) or a virtualizer associated with a virtual machine identifier (VIVID). The hypervisor 1180 may be identified by an attribute 1182 like the attribute 382 shown in FIG. 3. For example, the attribute 1182 may comprise a VMID. The hypervisor 1180 may execute a guest operating system hosting a guest process 1184. The guest process 1184 may also be like the process 380 shown in FIG. 3 and may be like the process 280B shown in FIG. 2. The guest process 1184 may be identified by an attribute 1186, which may also be like the attribute 382 shown in FIG. 3. For example, the attribute 1186 may comprise an ASID and/or an address space stored in a page table base register. The component(s) 1110 may be like the components of the processor core 110 shown in FIG. 1, such as one or more of the branch predictor 153A, the prefetcher 153B, the dispatch unit 154, the vector unit 155, the clock controller 194, and/or other components shown in FIG. 1, and/or like the component(s) 212 shown in FIG. 2.

To configure the component(s) 1110 on a per process basis, the hypervisor 1180 and/or the guest process 1184 may be identified. For example, the hypervisor 1180 may be identified based on the attribute 1182 (e.g., the VIVID), and the guest process 1184 may be identified based on the attribute 1186 (e.g., the ASID and/or the address space). Based on the attribute 1182 and/or the attribute 1186, a first set of parameters 1190 may be determined for use with the hypervisor 1180 and/or the guest process 1184. The first set of parameters 1190 may be stored in a memory system 1130 like the memory system 330 shown in FIG. 3. The component(s) 1110 of the processor core may then be configured using the first set of parameters 1190.

Implementations of this disclosure may include combinations of the components described in one or more of the foregoing figures. For example, an implementation of FIG. 3 may be capable of determining parameters using techniques described in more than one of FIGS. 4-11. For example, an implementation may include both process selection (e.g., as described with respect to the process selector 484 and the process manager 486 in FIG. 4) and process profiling (e.g., as described with respect to the process profiler 584 and the profiling information 586 in FIG. 5) and one or more parameters (e.g., the first set of parameters 390, 490, 590) may be determined differently depending on the process or other characteristic. For example, certain types of processes may have parameters determined differently from other types of processes. For example, one process may be configured to utilize process selection and another process may be configured to utilize process profiling. For example, model selection (e.g., including as described with respect to the model selector 784 shown in FIG. 7) may be utilized when a process is first executed, and process profiling may be utilized once sufficient profiling information is accumulated. For example, parameters may be determined differently for virtual machine hypervisor processes as compared to other processes.

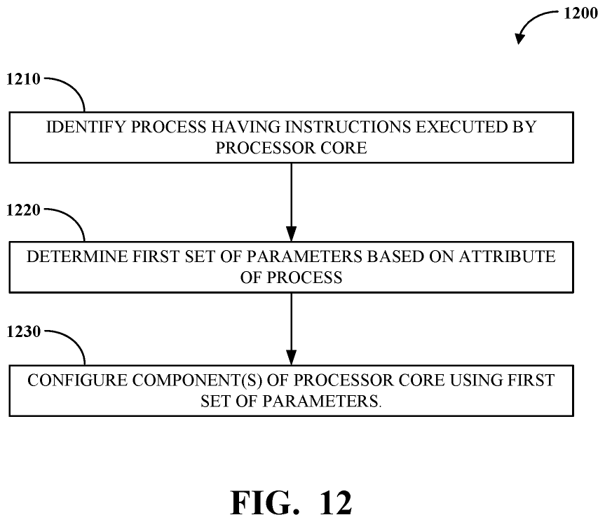

To further describe some implementations in greater detail, reference is next made to examples of methods which may be performed for configuring a component of a processor core. FIG. 12 is a flow chart of an example of a process 1200 for configuring one or more components of a processor core based on an attribute of a process. The process 1200 can be performed, for example, using the systems, hardware, and software described with respect to FIGS. 1-11 The steps, or operations, of the process 1200 or another technique, method, process, or algorithm described in connection with the implementations disclosed herein can be implemented directly in hardware, firmware, software executed by hardware, circuitry, or a combination thereof. Further, for simplicity of explanation, although the figures and descriptions herein may include sequences or series of steps or stages, elements of the methods and claims disclosed herein may occur in various orders or concurrently and need not include all of the steps or stages. Additionally, elements of the methods and claims disclosed herein may occur with other elements not explicitly presented and described herein. Furthermore, not all elements of the methods and claims described herein may be required in accordance with this disclosure. Although aspects, features, and elements are described and claimed herein in particular combinations, each aspect, feature, or element may be used and claimed independently or in various combinations with or without other aspects, features, and elements.

The process 1200 may include identifying 1210 a process having instructions executed by a processor core; determining 1220 a first set of parameters based on an attribute of the process; and configuring 1230 one or more components of the processor core using the first set of parameters.

The process 1200 includes identifying 1210 a process having instructions executed by a processor core. The process may be like the process 280A shown in FIG. 2, the process 380 shown in FIG. 3, the process 480 shown in FIG. 4, the process 580 shown in FIG. 5, the process 680 shown in FIG. 6, the process 780 shown in FIG. 7, the process 880 shown in FIG. 8, the process 980 shown in FIG. 9, the process 1080 shown in FIG. 10, the hypervisor 1180 shown in FIG. 11, and/or the guest process 1184 shown in FIG. 11. The process may be identified based on an attribute (e.g., the attribute 382) of the process. For example, the attribute may comprise an identifier, such as an ASID associated with the process (which may be stored in an address space register), an address space stored in a page table base register, a VMID, or a combination thereof. In some implementations, the attribute may be a range of memory addresses available to the process executing in the processor core. In some implementations, identifying the process, such as by the attribute, may include detecting the processor core executing to access a memory address within the range of memory addresses. In some implementations, the process may be identified via software (e.g., by the process, such as the process 280A shown in FIG. 2, and/or by another process, which could be a user level process, a supervisor process, and/or the kernel, such as the process 280B shown in FIG. 2), by hardware (e.g., by using microcode implemented by the processor core), by firmware, and/or by a combination thereof. In some implementations, a given phase of a process may be identified (e.g., different phases of a same process may be identified). In some implementations, a context switch to the process, and/or an address space change associated with the process, may cause the process to be identified.

The process 1200 also includes determining 1220 a first set of parameters based on an attribute of the process. The first set of parameters may be like the first set of parameters 390 shown in FIG. 3, the first set of parameters 490 shown in FIG. 4, the first set of parameters 590 shown in FIG. 5, the first set of parameters 690 shown in FIG. 6, the first set of parameters 790 shown in FIG. 7, the first set of parameters 890 shown in FIG. 8, the first set of parameters 990 shown in FIG. 9, the first set of parameters 1090 shown in FIG. 10, and/or the first set of parameters 1190 shown in FIG. 11. In some implementations, the first set of parameters may be determined via software (e.g., by the process, such as the process 280A shown in FIG. 2, and/or by another process, which could be a user level process, a supervisor process, and/or the kernel, such as the process 280B shown in FIG. 2), by hardware (e.g., by using microcode implemented by the processor core), by firmware, and/or by a combination thereof. In some implementations, the first set of parameters may be determined for a given phase of a process (e.g., a different first set of parameters may be determined for different phases of a same process). In some implementations, a context switch to the process, and/or an address space change associated with the process, may cause the first set of parameters to be determined. In some implementations, the first set of parameters may comprise an opaque data type that is not made available to a user level process).

The process 1200 also includes configuring 1230 one or more components of the processor core using the first set of parameters. The component(s) may be like the components of the processor core 110 shown in FIG. 1, such as one or more of the branch predictor 153A, the prefetcher 153B, the dispatch unit 154, the vector unit 155, the clock controller 194, and/or other components shown in FIG. 1, and/or like the component(s) 212 shown in FIG. 2. The component(s) may also be like the component(s) 310 shown in FIG. 3, the component(s) 410 shown in FIG. 4, the component(s) 510 shown in FIG. 5, the component(s) 610 shown in FIG. 6, the component(s) 710 shown in FIG. 7, the component(s) 810 shown in FIG. 8, the component(s) 910 shown in FIG. 9, the component(s) 1010 shown in FIG. 10, and/or the component(s) 1110 shown in FIG. 11. The component(s) of the processor core may be configured using the first set of parameters. In some implementations, the component(s) may be configured via software (e.g., by the process, such as the process 280A shown in FIG. 2, and/or by another process, which could be a user level process, a supervisor process, and/or the kernel, such as the process 280B shown in FIG. 2), by hardware (e.g., by using microcode implemented by the processor core), by firmware, and/or by a combination thereof. In some implementations, a context switch to the process, and/or an address space change associated with the process, may cause the component(s) to be configured. In some implementations, the component(s) may be configured for a given phase of a process (e.g., component(s) may be configured differently for different phases of a same process). In some implementations, the first set of parameters may be written to a register associated with the processor core to configure the component(s), such as via a “prctl( )” system call in Linux. Writing the first set of parameters to the register may implement the characteristics or behaviors of the processor core as the processor core executes the process (e.g., performance, power management, malware response, fault tolerance, and/or application security). In some implementations, the process may be executed within a security domain or context that isolates the first set of parameters from processes that are outside of the security domain or context. Thus, the first set of parameters may be used to configure the component(s) to control one or more of the characteristics or behaviors of the processor core as the processor core executes the process. This may permit configuring the microarchitecture of the processor core to control characteristics such as performance (e.g., execution speed), power management, malware response, fault tolerance, and/or application security.

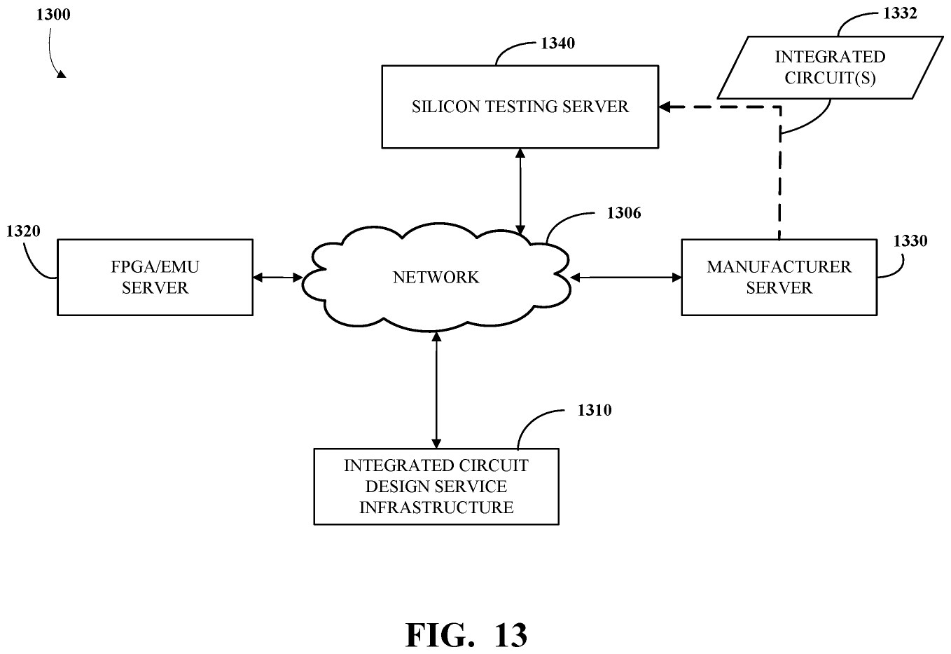

FIG. 13 is a block diagram of an example of a system 1300 for generation and manufacture of integrated circuits that configure a component of a processor core. The system 1300 includes a network 1306, an integrated circuit design service infrastructure 1310, a field programmable gate array (FPGA)/emulator server 1320, and a manufacturer server 1330. For example, a user may utilize a web client or a scripting application program interface (API) client to command the integrated circuit design service infrastructure 1310 to automatically generate an integrated circuit design based on a set of design parameter values selected by the user for one or more template integrated circuit designs. In some implementations, the integrated circuit design service infrastructure 1310 may be configured to generate an integrated circuit design with that configures a component of a processor as described in FIGS. 1-12.

The integrated circuit design service infrastructure 1310 may include a register-transfer level (RTL) service module configured to generate an RTL data structure for the integrated circuit based on a design parameters data structure. For example, the RTL service module may be implemented as Scala code. For example, the RTL service module may be implemented using Chisel. For example, the RTL service module may be implemented using a flexible intermediate representation for register-transfer level (FIRRTL). For example, the RTL service module may be implemented using Diplomacy. For example, the RTL service module may enable a well-designed chip to be automatically developed from a high level set of configuration settings using a mix of Diplomacy, Chisel, and FIRRTL. The RTL service module may take the design parameters data structure (e.g., a java script object notation (JSON) file) as input and output an RTL data structure (e.g., a Verilog file) for the chip.

In some implementations, the integrated circuit design service infrastructure 1310 may invoke (e.g., via network communications over the network 1306) testing of the resulting design that is performed by the FPGA/emulation server 1320 that is running one or more FPGAs or other types of hardware or software emulators. For example, the integrated circuit design service infrastructure 1310 may invoke a test using a field programmable gate array, programmed based on a field programmable gate array emulation data structure, to obtain an emulation result. The field programmable gate array may be operating on the FPGA/emulation server 1320, which may be a cloud server. Test results may be returned by the FPGA/emulation server 1320 to the integrated circuit design service infrastructure 1310 and relayed in a useful format to the user (e.g., via a web client or a scripting API client).

The integrated circuit design service infrastructure 1310 may also facilitate the manufacture of integrated circuits using the integrated circuit design in a manufacturing facility associated with the manufacturer server 1330. In some implementations, a physical design specification (e.g., a graphic data system (GDS) file, such as a GDSII file) based on a physical design data structure for the integrated circuit is transmitted to the manufacturer server 1330 to invoke manufacturing of the integrated circuit (e.g., using manufacturing equipment of the associated manufacturer). For example, the manufacturer server 1330 may host a foundry tape-out website that is configured to receive physical design specifications (e.g., such as a GDSII file or an open artwork system interchange standard (OASIS) file) to schedule or otherwise facilitate fabrication of integrated circuits. In some implementations, the integrated circuit design service infrastructure 1310 supports multi-tenancy to allow multiple integrated circuit designs (e.g., from one or more users) to share fixed costs of manufacturing (e.g., reticle/mask generation, and/or shuttles wafer tests). For example, the integrated circuit design service infrastructure 1310 may use a fixed package (e.g., a quasi-standardized packaging) that is defined to reduce fixed costs and facilitate sharing of reticle/mask, wafer test, and other fixed manufacturing costs. For example, the physical design specification may include one or more physical designs from one or more respective physical design data structures in order to facilitate multi-tenancy manufacturing.

In response to the transmission of the physical design specification, the manufacturer associated with the manufacturer server 1330 may fabricate and/or test integrated circuits based on the integrated circuit design. For example, the associated manufacturer (e.g., a foundry) may perform optical proximity correction (OPC) and similar post-tape-out/pre-production processing, fabricate the integrated circuit(s) 1332, update the integrated circuit design service infrastructure 1310 (e.g., via communications with a controller or a web application server) periodically or asynchronously on the status of the manufacturing process, perform appropriate testing (e.g., wafer testing), and send to a packaging house for packaging. A packaging house may receive the finished wafers or dice from the manufacturer and test materials and update the integrated circuit design service infrastructure 1310 on the status of the packaging and delivery process periodically or asynchronously. In some implementations, status updates may be relayed to the user when the user checks in using the web interface, and/or the controller might email the user that updates are available.

In some implementations, the resulting integrated circuit(s) 1332 (e.g., physical chips) are delivered (e.g., via mail) to a silicon testing service provider associated with a silicon testing server 1340. In some implementations, the resulting integrated circuit(s) 1332 (e.g., physical chips) are installed in a system controlled by the silicon testing server 1340 (e.g., a cloud server), making them quickly accessible to be run and tested remotely using network communications to control the operation of the integrated circuit(s) 1332. For example, a login to the silicon testing server 1340 controlling a manufactured integrated circuit(s) 1332 may be sent to the integrated circuit design service infrastructure 1310 and relayed to a user (e.g., via a web client). For example, the integrated circuit design service infrastructure 1310 may be used to control testing of one or more integrated circuit(s) 1332, which may be structured based on a design determined according to FIGS. 1-12.

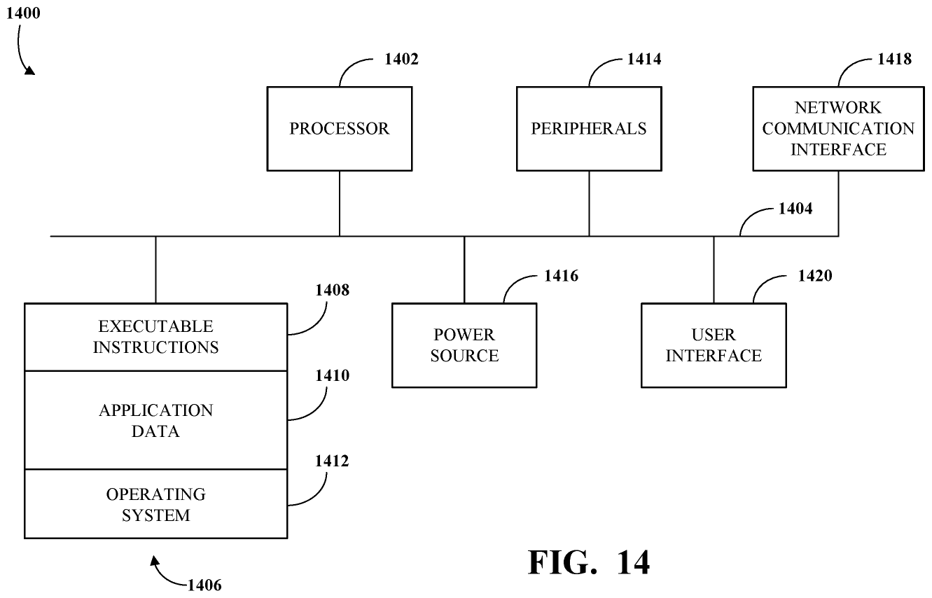

FIG. 14 is a block diagram of an example of a system 1400 for facilitating generation of integrated circuits that configure a component of a processor core, for facilitating generation of a circuit representation for an integrated circuit, and/or for programming or manufacturing an integrated circuit. The system 1400 is an example of an internal configuration of a computing device that may be used to implement the integrated circuit design service infrastructure 1310, and/or to generate a file that generates a circuit representation of an integrated circuit design as described in FIGS. 1-12. The system 1400 can include components or units, such as a processor 1402, a bus 1404, a memory 1406, peripherals 1414, a power source 1416, a network communication interface 1418, a user interface 1420, other suitable components, or a combination thereof.

The processor 1402 can be a central processing unit (CPU), such as a microprocessor, and can include single or multiple processors having single or multiple processing cores. Alternatively, the processor 1402 can include another type of device, or multiple devices, now existing or hereafter developed, capable of manipulating or processing information. For example, the processor 1402 can include multiple processors interconnected in any manner, including hardwired or networked, including wirelessly networked. In some implementations, the operations of the processor 1402 can be distributed across multiple physical devices or units that can be coupled directly or across a local area or other suitable type of network. In some implementations, the processor 1402 can include a cache, or cache memory, for local storage of operating data or instructions.

The memory 1406 can include volatile memory, non-volatile memory, or a combination thereof. For example, the memory 1406 can include volatile memory, such as one or more dynamic random access memory (DRAM) modules such as double data rate (DDR) synchronous DRAM (SDRAM), and non-volatile memory, such as a disk drive, a solid-state drive, flash memory, Phase-Change Memory (PCM), or any form of non-volatile memory capable of persistent electronic information storage, such as in the absence of an active power supply. The memory 1406 can include another type of device, or multiple devices, now existing or hereafter developed, capable of storing data or instructions for processing by the processor 1402. The processor 1402 can access or manipulate data in the memory 1406 via the bus 1404. Although shown as a single block in FIG. 14, the memory 1406 can be implemented as multiple units. For example, a system 1400 can include volatile memory, such as random access memory (RAM), and persistent memory, such as a hard drive or other storage.

The memory 1406 can include executable instructions 1408, data, such as application data 1410, an operating system 1412, or a combination thereof, for immediate access by the processor 1402. The executable instructions 1408 can include, for example, one or more application programs, which can be loaded or copied, in whole or in part, from non-volatile memory to volatile memory to be executed by the processor 1402. The executable instructions 1408 can be organized into programmable modules or algorithms, functional programs, codes, code segments, or combinations thereof to perform various functions described herein. For example, the executable instructions 1408 can include instructions executable by the processor 1402 to cause the system 1400 to automatically, in response to a command, generate an integrated circuit design and associated test results based on a design parameters data structure. The application data 1410 can include, for example, user files, database catalogs or dictionaries, configuration information or functional programs, such as a web browser, a web server, a database server, or a combination thereof. The operating system 1412 can be, for example, Microsoft Windows®, macOS®, or Linux®; an operating system for a small device, such as a smartphone or tablet device; or an operating system for a large device, such as a mainframe computer. The memory 1406 can comprise one or more devices and can utilize one or more types of storage, such as solid-state or magnetic storage.

The peripherals 1414 can be coupled to the processor 1402 via the bus 1404. The peripherals 1414 can be sensors or detectors, or devices containing any number of sensors or detectors, which can monitor the system 1400 itself or the environment around the system 1400. For example, a system 1400 can contain a temperature sensor for measuring temperatures of components of the system 1400, such as the processor 1402. Other sensors or detectors can be used with the system 1400, as can be contemplated. In some implementations, the power source 1416 can be a battery, and the system 1400 can operate independently of an external power distribution system. Any of the components of the system 1400, such as the peripherals 1414 or the power source 1416, can communicate with the processor 1402 via the bus 1404.

The network communication interface 1418 can also be coupled to the processor 1402 via the bus 1404. In some implementations, the network communication interface 1418 can comprise one or more transceivers. The network communication interface 1418 can, for example, provide a connection or link to a network, such as the network 1306 shown in FIG. 13, via a network interface, which can be a wired network interface, such as Ethernet, or a wireless network interface. For example, the system 1400 can communicate with other devices via the network communication interface 1418 and the network interface using one or more network protocols, such as Ethernet, transmission control protocol (TCP), Internet protocol (IP), power line communication (PLC), wireless fidelity (Wi-Fi), infrared, general packet radio service (GPRS), global system for mobile communications (GSM), code division multiple access (CDMA), or other suitable protocols.

A user interface 1420 can include a display; a positional input device, such as a mouse, touchpad, touchscreen, or the like; a keyboard; or other suitable human or machine interface devices. The user interface 1420 can be coupled to the processor 1402 via the bus 1404. Other interface devices that permit a user to program or otherwise use the system 1400 can be provided in addition to or as an alternative to a display. In some implementations, the user interface 1420 can include a display, which can be a liquid crystal display (LCD), a cathode-ray tube (CRT), a light emitting diode (LED) display (e.g., an organic light emitting diode (OLED) display), or other suitable display. In some implementations, a client or server can omit the peripherals 1414. The operations of the processor 1402 can be distributed across multiple clients or servers, which can be coupled directly or across a local area or other suitable type of network. The memory 1406 can be distributed across multiple clients or servers, such as network-based memory or memory in multiple clients or servers performing the operations of clients or servers. Although depicted here as a single bus, the bus 1404 can be composed of multiple buses, which can be connected to one another through various bridges, controllers, or adapters.

A non-transitory computer readable medium may store a circuit representation that, when processed by a computer, is used to program or manufacture an integrated circuit. For example, the circuit representation may describe the integrated circuit specified using a computer readable syntax. The computer readable syntax may specify the structure or function of the integrated circuit or a combination thereof. In some implementations, the circuit representation may take the form of a hardware description language (HDL) program, an RTL data structure, a flexible intermediate representation for register-transfer level (FIRRTL) data structure, a Graphic Design System II (GDSII) data structure, a netlist, or a combination thereof. In some implementations, the integrated circuit may take the form of an FPGA, an ASIC, an SoC, or some combination thereof. A computer may process the circuit representation in order to program or manufacture an integrated circuit, which may include programming an FPGA or manufacturing an ASIC or an SoC. In some implementations, the circuit representation may comprise a file that, when processed by a computer, may generate a new description of the integrated circuit. For example, the circuit representation could be written in a language such as Chisel, an HDL embedded in Scala, a statically typed general purpose programming language that supports both object-oriented programming and functional programming.

In an example, a circuit representation may be a Chisel language program which may be executed by the computer to produce a circuit representation expressed in a FIRRTL data structure. In some implementations, a design flow of processing steps may be utilized to process the circuit representation into one or more intermediate circuit representations followed by a final circuit representation which is then used to program or manufacture an integrated circuit. In one example, a circuit representation in the form of a Chisel program may be stored on a non-transitory computer readable medium and may be processed by a computer to produce a FIRRTL circuit representation. The FIRRTL circuit representation may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit.

In another example, a circuit representation in the form of Verilog or VHDL may be stored on a non-transitory computer readable medium and may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit. The foregoing steps may be executed by the same computer, different computers, or some combination thereof, depending on the implementation.

Some implementations may include a method that includes identifying a first operating system process having instructions configured to be executed by a processor core; determining a first set of parameters based on an attribute of the first operating system process; and configuring a component of the processor core using the first set of parameters. In some implementations, the method may include caching the first set of parameters in a memory system associated with the processor core. In some implementations, the caching step is implemented in software. In some implementations, determining the first set of parameters includes: obtaining a cached set of parameters as the first set of parameters, wherein the attribute is an identifier of the first operating system process. In some implementations, determining the first set of parameters includes: obtaining a cached set of parameters associated with the first operating system process; obtaining profiling information regarding execution of the first operating system process; and determining the first set of parameters based on the cached set of parameters and the profiling information. In some implementations, caching the first set of parameters includes updating a previously cached set of parameters associated with the first operating system process. In some implementations, determining the first set of parameters comprises: identifying a change in phase associated with the first operating system process; updating the first set of parameters based on the phase; and configuring the component of the processor core using the updated first set of parameters. In some implementations, determining the first set of parameters comprises: selecting a model from a plurality of models, wherein the model is selected based on the attribute of the first operating system process; and evaluating the model against a datum stored in a memory system associated with the processor core or a characteristic of the processor core to determine the first set of parameters. In some implementations, determining the first set of parameters comprises: accessing a model comprising a plurality of parameters, wherein the first set of parameters is selected from the plurality of parameters based on the first operating system process. In some implementations, the method may include executing a second operating system process, wherein the second operating system process determines the first set of parameters for the first operating system process. In some implementations, determining the first set of parameters includes using microcode implemented by the processor core to determine the first set of parameters. In some implementations, the component is one of a prefetcher, a branch predictor, a dispatch unit, a vector unit, or clock controller. In some implementations, the attribute is an address space identifier (ASID) and determining the first set of parameters includes: accessing a table comprising a plurality of parameters, wherein the ASID is used to determine the first set of parameters from the plurality of parameters in the table. In some implementations, the attribute is an address space stored in a page table base register implemented by the processor core and determining the first set of parameters includes: accessing a table comprising a plurality of parameters, wherein the page table base register is used to determine the first set of parameters from the plurality of parameters in the table. In some implementations, the method includes detecting a context switch from a prior operating system process to the first operating system process, wherein the steps of determining the first set of parameters and configuring the component are performed responsive to the context switch detection. In some implementations, the attribute is a range of memory addresses, and wherein identifying the first operating system process includes: detecting the processor core executing to access a memory address within the range of memory addresses. In some implementations, the first operating system process is executed in a user mode, and configuring the component includes: writing the first set of parameters by a second operating system process executed in a privileged mode. In some implementations, the first operating system process is a hypervisor executing a guest operating system and the attribute of the first operating system process includes a VMID. In some implementations, determining the first set of parameters includes: identifying a guest operating system process executed by the hypervisor; and determining the first set of parameters based on an attribute of the guest operating system process. In some implementations, configuring the component comprises configuring a clock signal to control power consumption associated with the component. In some implementations, configuring the component comprises configuring hardware to implement a redundancy associated with executing the first operating system process. In some implementations, configuring the component comprises configuring a dispatch unit to control a number of instructions to be executed by the processor core per clock cycle. In some implementations, determining the first set of parameters includes: predicting whether the first operating system process will cause an error; and determining the first set of parameters based on the prediction. In some implementations, determining the first set of parameters includes: obtaining profiling information regarding execution of the first operating system process; determining whether the first operating system process comprises malware based on the profiling information; and determining the first set of parameters based on determining that the first operating system process comprises malware. In some implementations, the first set of parameters configures the component to reduce speculative execution of the instructions. In some implementations, the instructions comprise vector instructions, and the first set of parameters configures the component to change a fault-first policy associated the vector instructions. In some implementations, configuring the component comprises configuring a PRNG seed, wherein the PRNG seed is specific to the first operating system process. In some implementations, configuring the component comprises configuring a dispatch unit to control multithreading. In some implementations, the method includes using a model to determine the first set of parameters; and executing the first operating system process in a security domain, wherein the security domain prevents a second operating system process from accessing the model.

Some implementations may include an apparatus that includes a processor core configured to: identify a first operating system process having instructions configured to be executed by the processor core; determine a first set of parameters based on an attribute of the first operating system process; and configure a component of the processor core using the first set of parameters. In some implementations, the processor core is configured to: cache the first set of parameters in a memory system associated with the processor core. In some implementations, the cache is implemented in software. In some implementations, the processor core is configured to: obtain a cached set of parameters as the first set of parameters, wherein the attribute is an identifier of the first operating system process. In some implementations, the processor core is configured to: obtain a cached set of parameters associated with the first operating system process; obtain profiling information regarding execution of the first operating system process; and determine the first set of parameters based on the cached set of parameters and the profiling information. In some implementations, the processor core is configured to update a previously cached set of parameters associated with the first operating system process. In some implementations, the processor core is configured to: identify a change in phase associated with the first operating system process; update the first set of parameters based on the phase; and configure the component of the processor core using the updated first set of parameters. In some implementations, the processor core is configured to: select a model from a plurality of models, wherein the model is selected based on the attribute of the first operating system process; and evaluate the model against a datum stored in a memory system associated with the processor core or a characteristic of the processor core to determine the first set of parameters. In some implementations, the processor core is configured to: access a model comprising a plurality of parameters, wherein the first set of parameters is selected from the plurality of parameters based on the first operating system process. In some implementations, the processor core is configured to: execute a second operating system process, wherein the second operating system process determines the first set of parameters for the first operating system process. In some implementations, the processor core is configured to determine the first set of parameters by using microcode implemented by the processor core to determine the first set of parameters. In some implementations, the component is one of a prefetcher, a branch predictor, a dispatch unit, a vector unit, or clock controller. In some implementations, the attribute is an ASID, and the processor core is configured to: access a table comprising a plurality of parameters, wherein the ASID is used to determine the first set of parameters from the plurality of parameters in the table. In some implementations, the attribute is an address space stored in a page table base register implemented by the processor core, and wherein the processor core is configured to: access a table comprising a plurality of parameters, wherein the page table base register is used to determine the first set of parameters from the plurality of parameters in the table. In some implementations, the processor core is configured to: detect a context switch from a prior operating system process to the first operating system process, determine the first set of parameters, and configure the component responsive to the context switch detection. In some implementations, the attribute is a range of memory addresses, and the processor core is configured to: detect the processor core executing to access a memory address within the range of memory addresses. In some implementations, the processor core is configured: execute the first operating system process in a user mode; and write the first set of parameters using a second operating system process executed in a privileged mode. In some implementations, the first operating system process is a hypervisor executing a guest operating system and the attribute of the first operating system process includes a VMID. In some implementations, the processor core is configured to: identify a guest operating system process executed by the hypervisor; and determine the first set of parameters based on an attribute of the guest operating system process. In some implementations, the processor core is configured to: configure a clock signal to control power consumption associated with the component. In some implementations, the processor core is configured to: configure hardware to implement a redundancy associated with executing the first operating system process. In some implementations, the processor core is configured to: configure a dispatch unit to control a number of instructions to be executed by the processor core per clock cycle. In some implementations, the processor core is configured to: predict whether the first operating system process will cause an error; and determine the first set of parameters based on the prediction. In some implementations, the processor core is configured to: obtain profiling information regarding execution of the first operating system process; determine whether the first operating system process comprises malware based on the profiling information; and determine the first set of parameters based on determining that the first operating system process comprises malware. In some implementations, the processor core is configured to: configure the component to reduce speculative execution of the instructions. In some implementations, the instructions comprise vector instructions, and wherein the processor core is configured to: configure the component to change a fault-first policy associated the vector instructions. In some implementations, the processor core is configured to: configure a PRNG seed, wherein the PRNG seed is specific to the first operating system process. In some implementations, the processor core is configured to: configure a dispatch unit to control multithreading. In some implementations, the processor core is configured to: use a model to determine the first set of parameters; and execute the first operating system process in a security domain, wherein the security domain prevents a second operating system process from accessing the model.

Some implementations may include a non-transitory computer readable medium that stores instructions operable to cause one or more processors to perform operations that include identifying a first operating system process having instructions configured to be executed by the processor core; determining a first set of parameters based on an attribute of the first operating system process; and configuring a component of the processor core using the first set of parameters. In some implementations, the operations may include caching the first set of parameters in a memory system associated with the processor core. In some implementations, the caching operation is implemented in software. In some implementations, the operations may include obtaining a cached set of parameters as the first set of parameters, wherein the attribute is an identifier of the first operating system process. In some implementations, the operations may include obtaining a cached set of parameters associated with the first operating system process; obtaining profiling information regarding execution of the first operating system process; and determining the first set of parameters based on the cached set of parameters and the profiling information. In some implementations, caching the first set of parameters includes updating a previously cached set of parameters associated with the first operating system process. In some implementations, the operations may include identifying a change in phase associated with the first operating system process; updating the first set of parameters based on the phase; and configuring the component of the processor core using the updated first set of parameters. In some implementations, the operations may include selecting a model from a plurality of models, wherein the model is selected based on the attribute of the first operating system process; and evaluating the model against a datum stored in a memory system associated with the processor core or a characteristic of the processor core to determine the first set of parameters. In some implementations, the operations may include accessing a model comprising a plurality of parameters, wherein the first set of parameters is selected from the plurality of parameters based on the first operating system process. In some implementations, the operations may include executing a second operating system process, wherein the second operating system process determines the first set of parameters for the first operating system process. In some implementations, determining the first set of parameters includes using microcode implemented by the processor core to determine the first set of parameters. In some implementations, the component is one of a prefetcher, a branch predictor, a dispatch unit, a vector unit, or clock controller. In some implementations, the attribute is an ASID, and the operations may include accessing a table comprising a plurality of parameters, wherein the ASID is used to determine the first set of parameters from the plurality of parameters in the table. In some implementations, the attribute is an address space stored in a page table base register implemented by the processor core, and the operations may include accessing a table comprising a plurality of parameters, wherein the page table base register is used to determine the first set of parameters from the plurality of parameters in the table. In some implementations, the operations may include detecting a context switch from a prior operating system process to the first operating system process, wherein the operations of determining the first set of parameters and configuring the component are performed responsive to the context switch detection. In some implementations, the attribute is a range of memory addresses, and the operations may include detecting the processor core executing to access a memory address within the range of memory addresses. In some implementations, the operations may include executing the first operating system process in a user mode; and writing the first set of parameters by a second operating system process executed in a privileged mode. In some implementations, the first operating system process is a hypervisor executing a guest operating system and the attribute of the first operating system process includes a VMID. In some implementations, the operations may include identifying a guest operating system process executed by the hypervisor; and determining the first set of parameters based on an attribute of the guest operating system process. In some implementations, the operations may include configuring the component comprises configuring a clock signal to control power consumption associated with the component. In some implementations, configuring the component comprises configuring hardware to implement a redundancy associated with executing the first operating system process. In some implementations, configuring the component comprises configuring a dispatch unit to control a number of instructions to be executed by the processor core per clock cycle. In some implementations, the operations may include predicting whether the first operating system process will cause an error; and determining the first set of parameters based on the prediction. In some implementations, the operations may include obtaining profiling information regarding execution of the first operating system process; determining whether the first operating system process comprises malware based on the profiling information; and determining the first set of parameters based on determining that the first operating system process comprises malware. In some implementations, the first set of parameters configures the component to reduce speculative execution of the instructions. In some implementations, the instructions comprise vector instructions, and the first set of parameters configures the component to change a fault-first policy associated the vector instructions. In some implementations, configuring the component comprises configuring a PRNG seed, wherein the PRNG seed is specific to the first operating system process. In some implementations, configuring the component comprises configuring a dispatch unit to control multithreading. In some implementations, the operations may include using a model to determine the first set of parameters; and executing the first operating system process in a security domain, wherein the security domain prevents a second operating system process from accessing the model.

As used herein, the term “circuitry” refers to an arrangement of electronic components (e.g., transistors, resistors, capacitors, and/or inductors) that is structured to implement one or more functions. For example, a circuit may include one or more transistors interconnected to form logic gates that collectively implement a logical function. While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures.

What is claimed is:

1. A method comprising:
identifying a first operating system process having instructions configured to be executed by a processor core;
determining a first set of parameters based on an attribute of the first operating system process; and
configuring a component of the processor core using the first set of parameters.

2. The method of claim 1, further comprising:
caching the first set of parameters in a memory system associated with the processor core.

3. The method of claim 1, wherein determining the first set of parameters includes:
obtaining a cached set of parameters as the first set of parameters, wherein the attribute is an identifier of the first operating system process.

4. The method of claim 1, wherein determining the first set of parameters includes:
obtaining a cached set of parameters associated with the first operating system process;
obtaining profiling information regarding execution of the first operating system process; and
determining the first set of parameters based on the cached set of parameters and the profiling information.

5. The method of claim 1, wherein determining the first set of parameters comprises:
identifying a change in phase associated with the first operating system process;
updating the first set of parameters based on the phase; and
configuring the component of the processor core using the updated first set of parameters.

6. The method of claim 1, wherein determining the first set of parameters comprises:
selecting a model from a plurality of models, wherein the model is selected based on the attribute of the first operating system process; and
evaluating the model against a datum stored in a memory system associated with the processor core or a characteristic of the processor core to determine the first set of parameters.

7. The method of claim 1, wherein determining the first set of parameters comprises:
accessing a model comprising a plurality of parameters, wherein the first set of parameters is selected from the plurality of parameters based on the first operating system process.

8. The method of claim 1, the method further comprising:
executing a second operating system process, wherein the second operating system process determines the first set of parameters for the first operating system process.

9. An apparatus comprising:
a processor core configured to:
identify a first operating system process having instructions configured to be executed by the processor core;
determine a first set of parameters based on an attribute of the first operating system process; and
configure a component of the processor core using the first set of parameters.

10. The apparatus of claim 9, wherein the processor core is configured to determine the first set of parameters by using microcode implemented by the processor core to determine the first set of parameters.

11. The apparatus of claim 9, wherein the component is one of a prefetcher, a branch predictor, a dispatch unit, a vector unit, or clock controller.

12. The apparatus of claim 9, wherein the attribute is an address space identifier (ASID), and wherein the processor core is configured to:
access a table comprising a plurality of parameters, wherein the ASID is used to determine the first set of parameters from the plurality of parameters in the table.

13. The apparatus of claim 9, wherein the attribute is an address space stored in a page table base register implemented by the processor core, and wherein the processor core is configured to:
access a table comprising a plurality of parameters, wherein the page table base register is used to determine the first set of parameters from the plurality of parameters in the table.

14. A non-transitory computer readable medium storing instructions operable to cause a processor core to perform operations comprising:
identifying a first operating system process having instructions configured to be executed by the processor core;
determining a first set of parameters based on an attribute of the first operating system process; and
configuring a component of the processor core using the first set of parameters.

15. The non-transitory computer readable medium storing instructions of claim 14, the operations further comprising:
detecting a context switch from a prior operating system process to the first operating system process, wherein the operations of determining the first set of parameters and configuring the component are performed responsive to the context switch detection.

16. The non-transitory computer readable medium storing instructions of claim 14, wherein the attribute is a range of memory addresses, the operations further comprising:
detecting the processor core executing to access a memory address within the range of memory addresses.

17. The non-transitory computer readable medium storing instructions of claim 14, the operations further comprising:
executing the first operating system process in a user mode; and
writing the first set of parameters by a second operating system process executed in a privileged mode.

18. The non-transitory computer readable medium storing instructions of claim 14, wherein the first operating system process is a hypervisor executing a guest operating system and the attribute of the first operating system process includes a virtual machine identifier (VIVID).

19. The non-transitory computer readable medium storing instructions of claim 14, wherein configuring the component comprises configuring a clock signal to control power consumption associated with the component.

20. The non-transitory computer readable medium storing instructions of claim 14, wherein configuring the component comprises configuring hardware to implement a redundancy associated with executing the first operating system process.
